(19) United States
(12) Patent Application Publication
(10) Pub. No.: US 2011/0105041 A1
(43) Pub. Date: May 5, 2011

(54) REMOTE CONTROL DEVICE, INTERNET HOME APPLICANCE, REMOTE CONTROL SYSTEM, AND REMOTE CONTROL METHOD

(75) Inventor: Tomoaki Maruyama, Tochigi (JP)

(73) Assignee: PANASONIC CORPORATION, Osaka (JP)

(21) Appl. No.: 13/001,666

(22) PCT Filed: May 19, 2009
(86) PCT No.: PCT/JP2009/002208

§ 371 Date: Dec. 28, 2010

(30) Foreign Application Priority Data
Jul. 30, 2008 (JP) 2008-197074

(51) Int. Cl. H04W 4/00

(52) U.S. Cl. 455/66.1

(57) ABSTRACT

Provided is a remote control device capable of remotely operating an Internet home appliance with little burden on the user. A remote control (400) remotely operates a camera (200) which sends self-identification information by an optical signal (510) and a television (300) (Internet home appliance) which sends the self-identification information by an optical signal (520), and has a receiver which receives the optical signal transmitted from the Internet home appliance, which is the remote control target, a network interface which connects to the communication network connected to the Internet home appliance, and a remote control unit which remotely controls an Internet home appliance which indicates the identification information via the communication network when the identification information of the Internet home appliance was received by the receiver when the specified operation was performed.

### TECHNICAL FIELD

The present invention relates to a remote control apparatus, remote control system, and remote control method for performing remote control of an Internet home appliance, and an Internet home appliance that receives remote control.

### BACKGROUND ART

In recent years, home appliances capable of connection to a communication network (hereinafter referred to as “Internet home appliances”) have become increasingly popular. In line with this, attention has been attracted to technology that reduces a user's operating burden by operating a plurality of Internet home appliances in a linked fashion. For example, there is a technology whereby, when DVD playback is performed by a DVD player, a television is also activated in a linked fashion, and the television display is switched to an input signal from the DVD player.

However, with the recent increasing sophistication of various kinds of Internet home appliances, and increased functional diversification through various combinations, a problem has arisen of how to implement a control interface for performing linked operation (hereinafter referred to as “linked control”) of a plurality of Internet home appliances. Various ideas have been tried regarding a control interface for performing linked control of Internet home appliances (see Patent Literature 1, for example).

Patent Literature 1 describes a technology relating to a control interface in which a GUI (graphical user interface) and desktop metaphor are applied. In the technology described in Patent Literature 1, a plurality of Internet home appliances are identified by means of image recognition, and an object indicating each Internet home appliance is displayed on the screen of a display apparatus such as the display of a personal computer. Then an Internet home appliance is controlled through correspondence to a control operation on an object on the screen by means of a pointing device attached to the personal computer. By this means, a user can easily and intuitively perform data transfer to/from an Internet home appliance, or an associated control operation, by performing a so-called drag and drop operation on the screen, for example.

A small, lightweight remote control has already become widely used as an Internet home appliance control interface. A remote control is a device for enabling a control operation to be performed easily and from a desired location. Therefore, it is also desirable for the above-described linked control of Internet home appliances to be implemented by means of a remote control.

Thus, it is conceivable for a technology whereby a drag and drop operation on a display apparatus is performed by means of a remote control (see Patent Literature 2, for example) to be applied to the above-described technology of Patent Literature 1.

In the technology described in Patent Literature 2, a plurality of light receiving sections are arranged on the display screen of a display apparatus, and a remote control is provided with a highly directional light-emitting section that outputs an optical signal. That is to say, by directing the remote control toward an object on the display screen, a control operation specifying that object can be performed. By applying the above-described Patent Literature 1 technology to this kind of technology described in Patent Literature 2, an above-described drag and drop operation can be performed easily by means of a remote control operation.

### CITATION LIST

### Patent Literature

### PTL 1

Patent 2001-136504 (p. 21, FIG. 1)

### PTL 2

International Pamphlet Publication No. 03/036829

### SUMMARY OF INVENTION

### Technical Problem

However, a technology combining Patent Literature 1 and Patent Literature 2 requires complex equipment for identifying the location of an Internet home appliance that is a linked control target by means of image recognition. Therefore, from the standpoints of securement of an equipment installation location, and installation cost, it is difficult for an individual user to install such technology. Thus, another idea is for a user to record the location of an Internet home appliance manually. However, not only is such a task burdensome, but re-recording is also necessary each time the location of an Internet home appliance changes. A further problem is that a display apparatus for displaying an object indicating an Internet home appliance is necessary, and a user must perform control operations while watching the display screen.

It is an object of the present invention to provide a remote control apparatus, remote control system, and remote control method that enable an Internet home appliance to be remotely controlled with less of a burden on a user, and an Internet home appliance that receives such remote control.

### Solution to Problem

A remote control apparatus of the present invention is a remote control apparatus for performing remote control of at least one Internet home appliance that sends self-identification information by means of a radio signal, and has: a signal receiving section that receives the radio signal sent from the Internet home appliance that is a target of the remote control; a communication network connection section that connects to a communication network to which the Internet home appliance is connected; and a remote control section that, when identification information of the Internet home appliance is received by the signal receiving section when a predetermined control operation is performed, performs remote control of the Internet home appliance indicated by that identification information via the communication network.

An Internet home appliance of the present invention is an Internet home appliance that is operated by the above remote control apparatus, and has: a signal sending section that sends self-identification information by means of a radio signal; a communication network connection section that connects to a communication network; and a remote control receiving section that receives remote control from the remote control apparatus via the communication network.

A remote control system of the present invention is a remote control system for performing remote control of at least one Internet home appliance that sends self-identification information by means of a radio signal, and is provided with: a remote control apparatus having a signal receiving section that receives the radio signal sent from the Internet home appliance that is a target of the remote control, a communication network connection section that connects to a communication network to which the Internet home appliance is connected, and a remote control section that, when identification information of the Internet home appliance is received by the signal receiving section when a predetermined control operation is performed, issues a request for a predetermined operation to the Internet home appliance indicated by that identification information via the communication network; and the Internet home appliance having a signal sending section that sends self-identification information by means of the radio signal, a communication network connection section that connects to the communication network, and a remote control receiving section that operates in accordance with a request of the remote control apparatus received via the communication network.

A remote control method of the present invention is a remote control method for performing remote control of at least one Internet home appliance that sends self-identification information by means of a radio signal, and has: a step of, when a predetermined control operation is performed, detecting that the predetermined control operation has been performed; and a step of performing remote control of the Internet home appliance indicated by identification information received when the fact that the predetermined control operation has been performed is detected among identification information of the Internet home appliance received by a signal receiving section that receives the radio signal sent from the Internet home appliance that is a target of the remote control via a communication network to which that Internet home appliance is connected.

### Advantageous Effects of Invention

According to the present invention, when an Internet home appliance sends identification information by means of a radio signal, a user can perform remote control of the Internet home appliance, without any particular need for complex equipment, based on which Internet home appliance is a target of a control operation performed by the user. By this means, the Internet home appliance can be remotely controlled with less of a burden on the user.

### BRIEF DESCRIPTION OF DRAWINGS

FIG. 1 is a schematic diagram showing a remote control system according to Embodiment 1 of the present invention;

FIG. 2 is a block diagram showing the configuration of a remote control according to Embodiment 1;

FIG. 3 is a perspective view of a remote control according to Embodiment 1;

FIG. 4 is a block diagram showing the configuration of a camera according to Embodiment 1;

FIG. 5 is a block diagram showing the configuration of a television according to Embodiment 1;

FIG. 6 is a flowchart showing the overall operation of a remote control according to Embodiment 1;

FIG. 7 is a drawing showing schematically an example of an active content acquisition request in Embodiment 1;

FIG. 8 is a drawing showing schematically an example of a response to an active content acquisition request in Embodiment 1;

FIG. 9 is a drawing showing schematically an example of an active content display request in Embodiment 1;

FIG. 10 is a drawing showing schematically an example of a response to an active content display request in Embodiment 1;

FIG. 11 is a flowchart showing remote control reception processing of a camera according to Embodiment 1;

FIG. 12 is a drawing showing an example of the contents of a photograph list as access information in Embodiment 1;

FIG. 13 is a flowchart showing remote control reception processing of a television according to Embodiment 1;

FIG. 14 is a perspective view showing an example of the appearance of a television according to Embodiment 1;

FIG. 15 is a drawing showing schematically an example of the overall operation of a remote control system according to Embodiment 1;

FIG. 16 is a sequence diagram of an example of the overall operation of a remote control system according to Embodiment 1;

FIG. 17 is a drawing showing the nature of image selection in a television according to Embodiment 2 of the present invention;

FIG. 18 is a block diagram showing the configuration of a remote control according to Embodiment 2;

FIG. 19 is a flowchart showing remote control reception processing of an Internet home appliance according to Embodiment 2;

FIG. 20 is a drawing showing schematically an example of the overall operation of a remote control system according to Embodiment 2;

FIG. 21 is a sequence diagram of an example of the overall operation of a remote control system according to Embodiment 2;

FIG. 22 is a drawing showing how a photograph is focused upon on a television according to Embodiment 2;

FIG. 23 is a block diagram showing the configuration of an air conditioner according to Embodiment 3;

FIG. 24 is a drawing showing schematically an example of the overall operation of a remote control system according to Embodiment 3;

FIG. 25 is a perspective view showing an example of the appearance of a television according to Embodiment 3;

FIG. 26 is a system configuration diagram showing the configuration of a remote control system according to Embodiment 4 of the present invention;

FIG. 27 is a block diagram showing the configuration of a videophone according to Embodiment 4;

FIG. 28 is a drawing showing schematically how synchronization of graphic object display is performed in Embodiment 4;

FIG. 29 is a flowchart showing the operation of a synchronization section in Embodiment 4;

FIG. 30 is a drawing showing an example of the contents of an active content display request in Embodiment 4;

FIG. 31 is a drawing showing schematically an example of the overall operation of a remote control system according to Embodiment 4; and

FIG. 32 is a sequence diagram of an example of the overall operation of a remote control system according to Embodiment 4.

### DESCRIPTION OF EMBODIMENTS

Now, embodiments of the present invention will be described in detail with reference to the accompanying drawings.

In the embodiments, “active content” is used as a generic term for a content body that is content that is a target of movement between Internet home appliances, and access information that is information for accessing a content body.

Specifically, active content denotes the following three concepts, for example.

The first concept is so-called content or a content list. Here, “so-called content” denotes a representational item such as video, music, speech, a photograph, text, or the like, played back or stored by an Internet home appliance, or program data executed by an Internet home appliance. “Internet home appliance” is a generic term denoting electrical equipment for home use that is connected to a communication network, as referred to above. Content includes both static and dynamic content. The former is, for example, video stored in a hard-disk video recorder or a photograph taken with a digital still camera. The latter is, for example, music streaming content or a program being broadcast in a television broadcast. Content may be content data itself, or a pointer indicating that content (for example, a URL for that content).

The second concept is a user interface for operating (controlling) an Internet home appliance. For example, this is a recording programming screen on a hard-disk video recorder, or a room-temperature setting/air-current switching screen in the case of an air conditioner.

The third concept is information indicating the state of an Internet home appliance or a state external to an Internet home appliance. For example, this is information indicating the set temperature of an air conditioner, or the room temperature and humidity.

### Embodiment 1

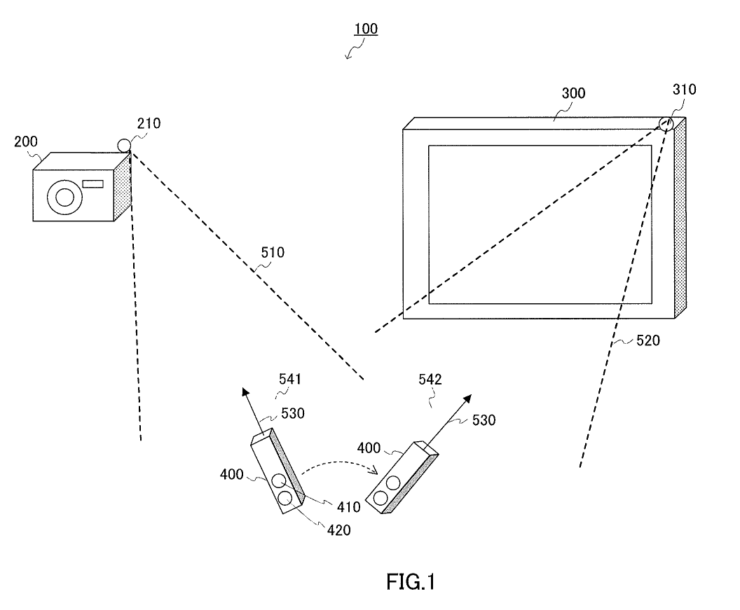

FIG. 1 is a schematic diagram showing a remote control system according to Embodiment 1 of the present invention. In this embodiment, an example will be described in which the present invention is applied to a remote control system in which active content can be moved between Internet home appliances in real space, using a drag and drop operation by means of a remote control. In this embodiment, digital data of a photograph held in a camera is assumed to be a content body, and data describing a pointer to this digital data is assumed to be access information.

As shown in FIG. 1, remote control system 100 of this embodiment has camera 200 and television 300 as Internet home appliances according to the present invention, and remote control 400 as a remote control apparatus according to the present invention.

Camera 200, television 300, and remote control 400 are, for example, placed in the living room of a home, and are mutually connected via a wireless or wired IP (internet protocol) network (not shown). Camera 200, television 300, and remote control 400 each have HTTP (hypertext transfer protocol) and REST (representational state transfer) installed, and are capable of HTTP message exchange and remote function calls.

Camera 200 is a digital still camera having a photographic function, and holds digital data comprising photographs that have been taken (hereinafter referred to as “photographic data”). Camera 200 generates a content list obtained by making a list of content body URLs (uniform resource locators) (hereinafter referred to as a “photograph list”) as access information for accessing these content bodies. A content body need not necessarily be all the photographic data held in camera 200, but may be only part of the stored photographic data, such as photographic data captured within a week, for example.

Camera 200 has optical beacon 210 on the external surface of its body, and periodically emits optical signal 510 including self-identification information from this optical beacon 210. Optical signal 510 is, for example, a signal obtained by modulating infrared light of a predetermined wavelength. Details of the identification information included in optical signal 510 will be given later herein.

On receiving an HTTP GET request (hereinafter referred to for convenience as “GET request”) via the communication network, camera 200 sends back information specified by this GET request. At this time, camera 200 sends back access information (here, a photograph list) if access information is specified, or sends back a specified content body if a content body is specified.

Television 300 has a video display function, and displays on its screen not only normal video via a television broadcast, but also video acquired from the IP network.

Television 300 has optical beacon 310 on the external surface of its body, and periodically emits optical signal 520 including self-identification information from this optical beacon 310. In the same way as optical signal 510 of camera 200, optical signal 520 is, for example, a signal obtained by modulating infrared light of a predetermined wavelength.

On receiving an HTTP POST request (hereinafter referred to for convenience as “POST request”) via the communication network, television 300 sends back information specified by this POST request. At this time, if access information is specified, television 300 accesses a content body held in another Internet home appliance based on the access information. If the access information specified by the POST request is an above-described photograph list, television 300 acquires photographic data from camera 200 by transmitting a GET request specifying a URL written in the photograph list to camera 200, and displays the photographic data on its screen.

Remote control 400 receives the above-described infrared light of a predetermined wavelength in directivity direction (hereinafter referred to as “orientation”) 530 with the apparatus body as a reference. That is to say, when orientation 530 is directed toward camera 200, remote control 400 receives optical signal 510 of camera 200, and when orientation 530 is directed toward television 300, remote control 400 receives optical signal 520 of television 300.

Remote control 400 has GET button 410 and PUT button 420. On receiving an optical signal when GET button 410 is pressed, remote control 400 transmits a GET request specifying access information to the Internet home appliance corresponding to identification information included in that optical signal. Remote control 400 acquires access information from the Internet home appliance by means of this GET request. Then, on receiving an optical signal when PUT button 420 is pressed, remote control 400 transmits a POST request specifying the access information acquired immediately before to the Internet home appliance corresponding to identification information included in that optical signal.

According to remote control system 100 of this kind, photographic data in camera 200 can be displayed on television 300 by means of simple remote control 400 operations. Specifically, the user first presses GET button 410 in a state (541) in which remote control 400 is directed toward camera 200, and then presses PUT button 420 in a state (542) in which remote control 400 is directed toward television 300.

The functions of a GET request and POST request in remote control system 100 differ according to the transmission destination and type of specification target.

A GET request specifying access information transmitted from remote control 400 to camera 200 via the network functions as a request for acquiring access information and a content body from outside. Hereinafter, this kind of GET request is referred to for convenience as an “active content acquisition request”.

A POST request specifying a camera 200 photograph list transmitted from remote control 400 to television 300 via the network functions as a request for acquiring and displaying a content body. Hereinafter, this kind of POST request is referred to for convenience as an “active content display request”.

A GET request specifying a camera 200 content body transmitted from television 300 to camera 200 via the network functions as a request for sending back a content body. Hereinafter, this kind of GET request is referred to for convenience as a “content transmission request”.

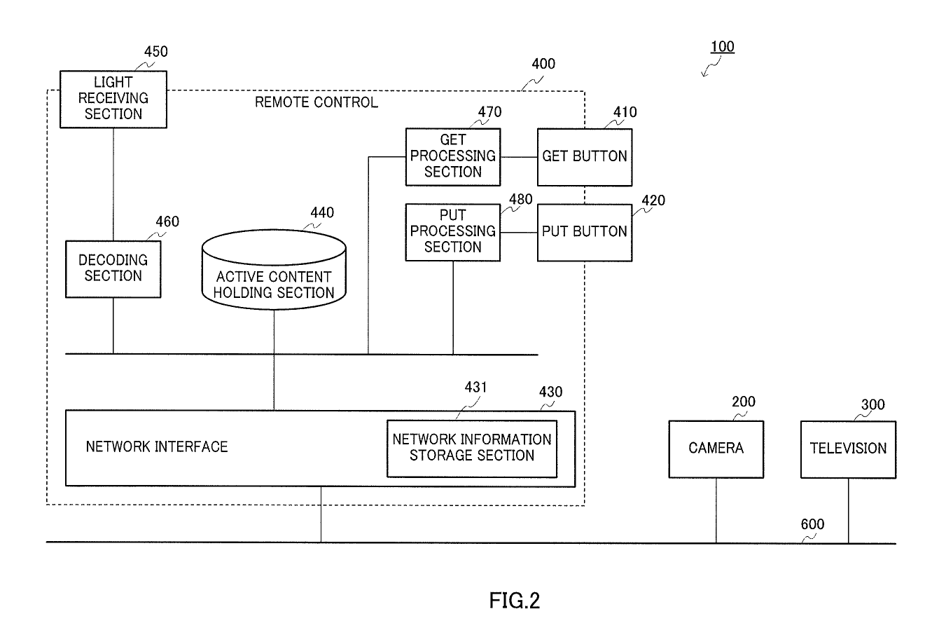

FIG. 2 is a block diagram showing the configuration of remote control 400, and also shows the communication network, camera 200, and television 300.

As shown in FIG. 2, remote control 400, camera 200, and television 300 are connected to communication network 600 that is the above-described IP network. In FIG. 2, remote control 400 has network interface 430, active content holding section 440, light receiving section 450, decoding section 460, GET button 410, GET processing section 470, PUT button 420, and PUT processing section 480.

Network interface 430 connects to communication network 600, and performs communication with other Internet home appliances. Network interface 430 is an entire function block that includes hardware such as a network interface card and software, and comprises communication functions and an implementation stage thereof covering a span from the physical layer to the application layer. Specifically, network interface 430 includes hardware and a driver for connecting to communication network 600, management software, a TCP (transmission control protocol) protocol stack, an IP protocol stack, an HTTP (hypertext transfer protocol) protocol stack, an HTTP server function, an HTTP client function, and an REST function.

Network interface 430 holds network information in network information storage section 431 that stores network information. Network information held in network information storage section 431 includes a network mask of communication network 600 and an IP address assigned to remote control 400. This network mask and IP address are set, for example, by a DHCP (dynamic host configuration protocol) server (not shown) located in communication network 600 when remote control 400 connects to communication network 600.

Active content holding section 440 holds various kinds of data, including a photograph list acquired from camera 200 by GET processing section 470, described later herein.

Light receiving section 450 has a light receiving element (not shown) that receives infrared light used by optical beacons 210 and 310 from camera 200 and television 300. Light receiving section 450 receives optical signals from camera 200 and television 300.

Decoding section 460 decodes identification information included in an optical signal from an optical signal received by light receiving section 450. Also, decoding section 460 acquires an IP address in a communication network that is the transmission source of identification information (hereinafter referred to simply as “IP address”) based on acquired identification information, and stores this IP address in active content holding section 440.

GET button 410 is a key switch provided on the external surface of the apparatus, and outputs an execution trigger to GET processing section 470 when pressed by the user.

GET processing section 470 generates a GET request specifying access information with the IP address last stored in active content holding section 440 by decoding section 460 as a destination, and transmits this GET request from network interface 430. Also, GET processing section 470 stores access information acquired as a response to a GET request in active content holding section 440.

PUT button 420 is a key switch provided on the external surface of the apparatus, and outputs an execution trigger to PUT processing section 480 when pressed by the user.

PUT processing section 480 generates a POST request specifying access information last stored in active content holding section 440, with the IP address last stored in active content holding section 440 by decoding section 460 as a destination. Then PUT processing section 480 transmits the generated POST request from network interface 430.

Remote control 400 has, for example, a CPU (central processing unit), a storage medium such as ROM (read only memory) that stores a control program, working memory such as RAM (random access memory), and so forth. In this case, the functions of the above sections are implemented by execution of the control program by the CPU.

According to remote control 400 of this kind, when GET button 410 is pressed in a state in which light receiving section 450 is directed toward camera 200, a GET request specifying access information can be transmitted to camera 200 via communication network 600. That is to say, remote control 400 can transmit an active content acquisition request. Then, when PUT button 420 is pressed in a state in which light receiving section 450 is directed toward television 300, a POST request specifying camera 200 access information can be transmitted to television 300 via communication network 600. That is to say, remote control 400 can transmit an active content display request.

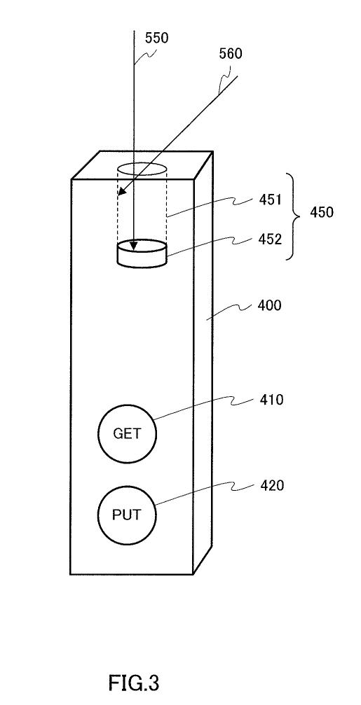

FIG. 3 is a perspective view of remote control 400.

As shown in FIG. 3, remote control 400 has a stick (bar) shape, and is designed so that the lower part in the drawing is held and operated by a user. GET button 410 and PUT button 420 are provided at positions where they are easily pressed by the user while holding remote control 400. A columnar hole 451 is provided in the front end of remote control 400, and light receiving element 452 is located on the bottom surface of hole 451. The side surface of hole 451 is made of a material that absorbs infrared radiation, and directivity of light receiving section 450 is implemented by means of the shape of hole 451 and the position of light receiving element 452. That is to say, light receiving section 450 has a configuration such that only infrared light 550 coming from the direction toward the front end of remote control 400 (the axial direction of hole 451) reaches light receiving element 452, and infrared light 560 coming from an oblique direction does not reach light receiving element 452. By this means, directivity of light receiving section 450 is implemented.

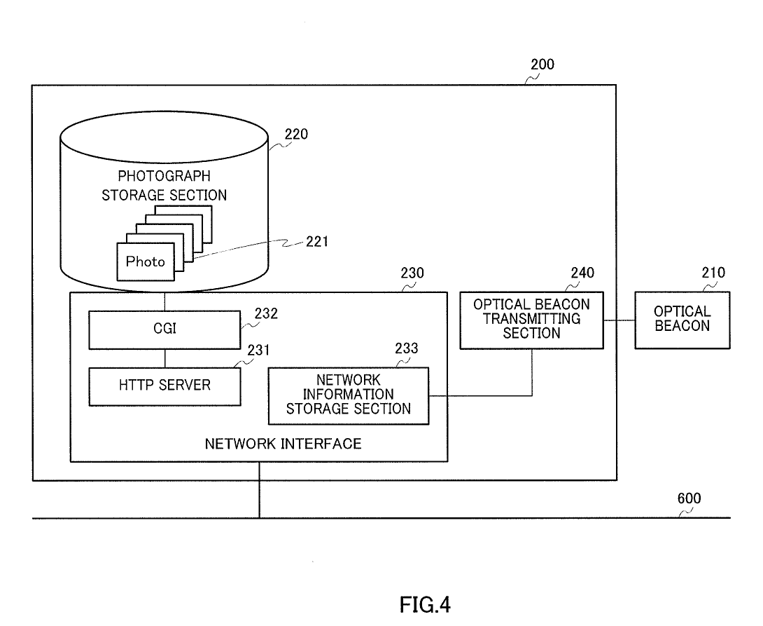

FIG. 4 is a block diagram showing the configuration of camera 200, and also shows communication network 600.

As shown in FIG. 4, camera 200 has photograph storage section 220, network interface 230, optical beacon 210, and optical beacon transmitting section 240.

Photograph storage section 220 holds photographic data 221. Photograph storage section 220 is memory card such as an SD (secure digital) card, for example. Photographic data 221 is, for example, image data of a photograph captured by an imaging section (not shown) that performs photography, being a content body that is a movement target in this embodiment. Photographic data 221 is, for example, JPEG (Joint Photographic Experts Group) data. Since many digital still cameras now incorporate a function for shooting video, a content body may also be video data.

Like network interface 430 of remote control 400, network interface 230 has a function for connecting to communication network 600. Network interface 230 has HTTP server 231, CGI (common gateway interface) 232, and network information storage section 233, as internal elements.

HTTP server 231 performs various kinds of processing in accordance with HTTP. When security-related conditions are met, HTTP server 231 receives a request from another Internet home appliance accessed in accordance with HTTP. This request may be for transmission of photographic data 221 or activation of CGI 232 described later herein, for example.

CGI 232 is a CGI that is called and activated when HTTP server 231 receives a GET request specifying access information (an active content acquisition request). CGI 232 creates a photograph list of photographic data 221 stored in photograph storage section 220, and transmits information put into a predetermined format such as an XML (extensible markup language) format, for example, to the sender of the active content acquisition request as access information.

Network information storage section 233 holds network information. Network information held in network information storage section 233 includes a communication network 600 network mask and an IP address assigned to camera 200. This network mask and IP address are set by a DHTP server located in communication network 600 when camera 200 connects to communication network 600, for example.

Optical beacon 210 is connected in a removable fashion to the body of remote control 400. Optical beacon 210 should send optical signals in as many directions as possible, and should preferably employ a surface emitting light source, or a light source comprising a number of comparatively wide-angle light emitting diodes, as a light source. Also, it is desirable for optical beacon 210 to have a configuration such that, for example, an infrared light emitting diode widely used as a TV remote control optical signal transmission element, and an associated drive circuit, are connected to the body of remote control 400 by means of a general-purpose interface such as a serial interface. By this means, it is possible for optical beacon 210 to be configured inexpensively.

Optical beacon transmitting section 240 generates a signal corresponding to alphanumeric characters and symbols (so-called ASCII characters), and transmits optical beacon 210 in a pattern in accordance with that signal. Optical beacon transmitting section 240 of this embodiment generates self-identification information based on an IP address stored in network information storage section 233 of network interface 230. An optical signal in which identification information generated by optical beacon transmitting section 240 is encoded is transmitted from optical beacon 210 in cycles of around two or three times a second, for example. It is desirable for optical beacon transmitting section 240 to have software installed that controls optical beacon 210 via the above-described serial interface. This makes it possible for an optical beacon transmission function to be added inexpensively, after purchase, to a general-purpose Internet home appliance having a serial interface and a software (driver) installation function.

Camera 200 has, for example, a CPU, a storage medium such as ROM that stores a control program, working memory such as RAM, and so forth. In this case, the functions of the above sections are implemented by execution of the control program by the CPU.

According to camera 200 of this kind, an optical signal including self-identification information can be transmitted periodically. Also, when a GET request specifying access information (an active content acquisition request) is received, access information (a photograph list) can be sent back via communication network 600. Furthermore, when a GET request specifying a content body (a content transmission request) is received, a content body can be sent back via communication network 600.

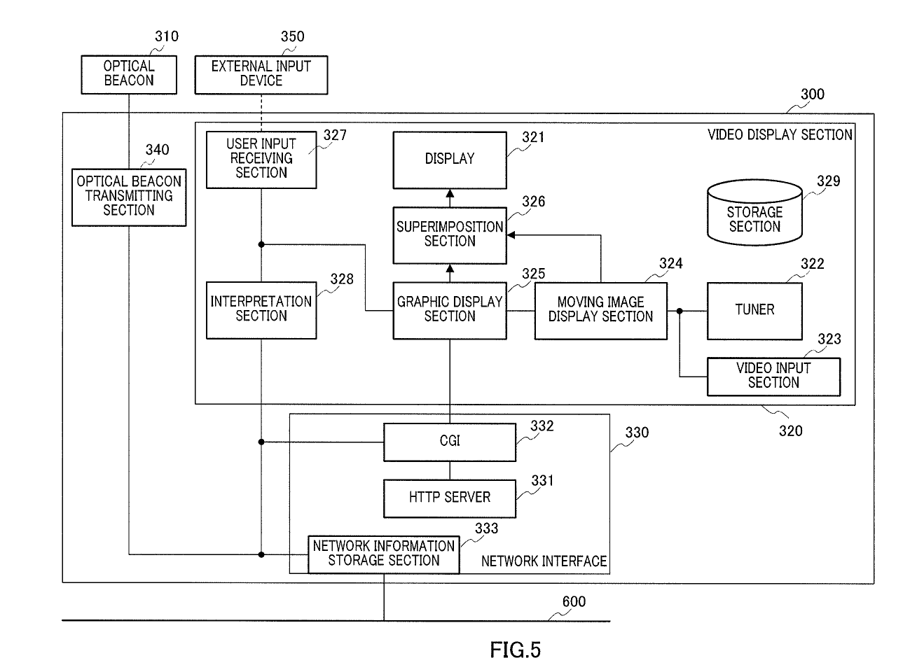

FIG. 5 is a block diagram showing the configuration of television 300.

As shown in FIG. 5, television 300 has video display section 320, network interface 330, and optical beacon transmitting section 340.

Video display section 320 displays video of digital video data including video broadcast by means of a television broadcast. Video display section 320 has display 321, tuner 322, video input section 323, moving image display section 324, graphic display section 325, superimposition section 326, user input receiving section 327, interpretation section 328, and storage section 329.

Display 321 has, for example, a liquid crystal display panel (not shown), and displays video.

Tuner 322 is a section for receiving a broadcast wave of a television broadcast, and extracts a video signal from a received broadcast wave.

Video input section 323 inputs a video signal from an external device such as a DVD player.

Moving image display section 324 displays video on the screen of video display section 320 based on a video signal output from tuner 322 or a video signal output from video input section 323.

Graphic display section 325 performs image drawing (rendering) based on image data input via network interface 330.

Superimposition section 326 displays an image rendered by graphic display section 325 on display 321, superimposed on video displayed by moving image display section 324.

User input receiving section 327 receives a user operation on video displayed on display 321. Specifically, user input receiving section 327 receives, from external input device 350 such as a television 300 remote control or a pointing device, information indicating the contents of a user operation on external input device 350. User operations include, for example, operations to perform changing of the display position, enlargement of the display size, or deletion from the screen, of an image rendered by graphic display section 325.

Interpretation section 328 interprets a signal output from user input receiving section 327, and implements processing corresponding to a user operation using a CGI described later herein.

Storage section 416 is a general-purpose storage apparatus used for data storage when it is necessary for television 300 sections to operate.

Like network interface 230 of camera 200, network interface 330 has a function for connecting to communication network 600. Network interface 330 has HTTP server 331, CGI 332, and network information storage section 333, as internal elements.

Like HTTP server 231 of camera 200, HTTP server 331 performs various kinds of processing in accordance with HTTP.

CGI 332 is a CGI that is called and activated when HTTP server 231 receives a POST request specifying access information (an active content display request). If the type of data specified by the body section of the POST request is a photographic data or suchlike image data list (photograph list), CGI 332 accesses that URL, and acquires a corresponding content body.

Network information storage section 333 holds network information. Network information held in network information storage section 333 includes a communication network 600 network mask and an IP address assigned to television 300. This network mask and IP address are set by a DHTP server located in communication network 600 when television 300 connects to communication network 600, for example.

In a similar way to optical beacon 210 of camera 200, optical beacon 310 is connected in a removable fashion to the body of television 300.

In a similar way to optical beacon transmitting section 340 of camera 200, optical beacon transmitting section 340 transmits from optical beacon 210 an optical signal in which self-identification information is encoded, based on an IP address stored in network information storage section 333 of network interface 330.

Television 300 has, for example, a CPU, a storage medium such as an HDD (hard disk drive) that stores a control program, working memory such as RAM, and so forth. In this case, the functions of the above sections are implemented by execution of the control program by the CPU.

According to television 300 of this kind, an optical signal including self-identification information can be transmitted periodically. Also, when a POST request specifying access information (an active content display request) is received, a content body can be acquired and displayed based on the access information (photograph list).

Identification information transmitted and received by means of an optical signal will now be described.

In this embodiment, to simplify the explanation, network addresses used are assumed to be IPv4 (internet protocol version 4) addresses. Communication network 600 is a small-scale network comprising a single subnet, and of the four octets of an IPv4 address, the upper three octets are assumed to be a network section, and the lowest octet is assumed to be a host section. An octet denotes an 8-bit unit of information.

Below, it is assumed that the network address of communication network 600 is “192.168.1.0” (the network mask being “255.255.255.0”), the IP address of camera 200 is “192.168.1.123”, and the IP address of television 300 is “192.168.1.124”.

Camera 200 and television 300 employ the host section (lowest octet) of the IP addresses assigned to them as identification information that is transmitted by means of an optical signal. Therefore, camera 200 takes its self-identification information to be “123”, and television 300 takes its self-identification information to be “124”. Also, in order to improve transmission efficiency, camera 200 and television 300 convert identification information from decimal to hexadecimal notation, and transmit a converted character string by means of an optical signal. Therefore, camera 200 transmits character string “7B” as identification information, and television 300 transmits character string “7C” as identification information. The transmission time for hexadecimal data comprising a 2-digit numeric value can be reduced by approximately 33% compared with that for decimal data comprising a 3-digit numeric value.

On the other hand, remote control 400 decodes an original IP address from identification information included in a received optical signal on the assumption that camera 200 and television 300 have sent identification information by means of the above-described method. Specifically, remote control 400 converts extracted identification information to a decimal character string, and generates an IP address by placing this converted character string in the octet after “198.168.1”.

Thus, remote control system 100 employs data obtained by reversibly converting an IP address to data of smaller size as identification information. By this means, IP address notification from an Internet home appliance to remote control 400 can be implemented in a state in which the amount of data and transmission time for each transmission has been reduced.

The identification information encoding method and protocol are not limited to specific types. For example, a format for a television remote control standardized by the Association for Electric Home Appliances may also be used, adapted to transmission of a 2-digit hexadecimal character string.

The operation of remote control system 100 having the above configuration will now be described. First, the overall operation of remote control 400 will be described, followed by a description of camera 200 and television 300 processing for receiving remote control by means of remote control 400 (hereinafter referred to as “remote control reception processing”). Then the overall operation of remote control system 100 will be described, using an example of user operation.

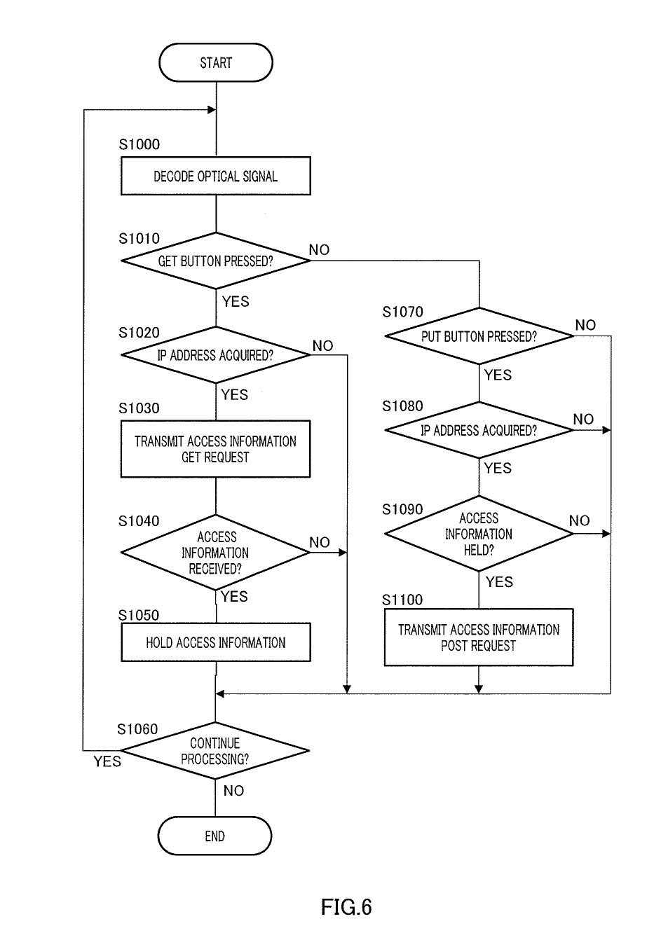

FIG. 6 is a flowchart showing the overall operation of remote control 400.

First, in step S1000, decoding section 460 performs processing that attempts decoding of an optical signal received by light receiving section 450. Specifically, decoding section 460 starts operation with light reception by light receiving section 450 as a trigger, and stores a result of decoding an optical signal received by light receiving section 450 in active content holding section 440. For example, when processing is performed in a state in which remote control 400 is directed toward camera 200, at this point in time the IP address of camera 200 is stored in active content holding section 440 by decoding section 460. Decoding section 460 may also store a decoded result in active content holding section 440 at timing at which the GET button or PUT button is pressed. If processing is performed in a state in which remote control 400 is not directed toward any Internet home appliance, storage of an Internet home appliance IP address in active content holding section 440 is not performed.

There is a possibility of a user performing an unwanted operation if the IP address of camera 200 is stored despite the fact that a long time has elapsed since remote control 400 was directed toward any Internet home appliance. Therefore, to prevent such a situation, it is desirable for decoding section 460 to delete an IP address from active content holding section 440 if a certain time has elapsed since that IP address was stored.

Also, a better user interface is provided if provision is made for remote control 400 to notify the user, using sound, light, vibration, or the like, each time a result of decoding a received optical signal is obtained. This enables the user to be aware that remote control 400 is directed toward a target Internet home appliance—that is, to be aware that remote control 400 is able to acquire identification information.

Then, in step S1010, GET processing section 470 determines whether or not GET button 410 has been pressed by the user—that is, whether or not an execution trigger has been input from GET button 410. If GET button 410 has been pressed (S1010: YES), GET processing section 470 proceeds to step S1020.

In step S1020, GET processing section 470 determines whether or not a corresponding IP address has been acquired from active content holding section 440, and proceeds to step S1030 if an IP address has been acquired (S1020: YES). The above IP address is the IP address of an Internet home appliance toward which remote control 400 was directed when GET button 410 was pressed, or immediately before that.

In step S1030, GET processing section 470 transmits a GET request specifying access information, with the IP address acquired in step S1020 as a destination. If GET button 410 was pressed in a state in which remote control 400 was directed toward camera 200, this GET request is an active content acquisition request.

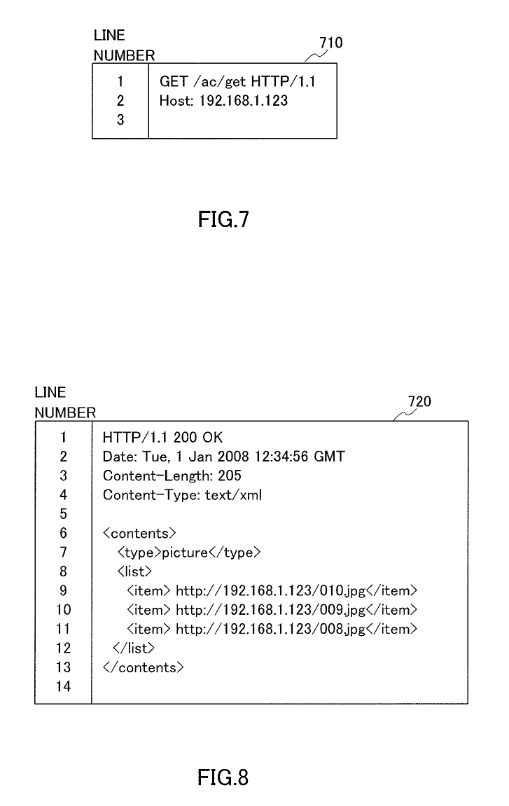

FIG. 7 is a drawing showing schematically an example of an active content acquisition request.

As shown in FIG. 7, active content acquisition request 710 is an HTTP GET request, in which “/ac/get” is written as a destination path (line number 1). Therefore, a URL for acquiring active content is “http://192.168.1.123/ac/get”. CGI 232 is activated by means of this URL. That is to say, the access information specification in a GET request to camera 200 specifies activation of CGI 232.

An HTTP 200 OK response is sent back from camera 200 in response to a GET request. When the GET request is the active content acquisition request shown in FIG. 7, access information (a photograph list) generated by CGI 232 of camera 200 is sent back from camera 200 in response.

FIG. 8 is a drawing showing schematically an example of a response to the active content acquisition request shown in FIG. 7.

As shown in FIG. 8, access information (a photograph list) generated by CGI 232 is written in the body section (line numbers 6 through 13) of response 720 to the active content acquisition request. Also, “picture”, enclosed by “type” tags, is written in the body section. This indicates that the type of data specified by the body section is an image list (photograph list) comprising photographic data or the like.

In step S1040 in FIG. 6, GET processing section 470 determines whether or not access information has been received in response to the GET request, and proceeds to step S1050 if access information has been received (S1040: YES). If GET button 410 was pressed in a state in which remote control 400 was directed toward camera 200, this access information becomes a camera 200 photograph list.

In step S1050, GET processing section 470 holds the acquired access information in active content holding section 440.

There is a possibility of a user performing an unwanted operation if GET processing section 470 is holding access information despite the fact that a long time has elapsed since GET button 410 was pressed. Therefore, to prevent such a situation, it is desirable for GET processing section 470 to delete access information from active content holding section 440 if a certain time has elapsed since that access information was stored.

Also, a better user interface is provided if provision is made for remote control 400 to notify the user that held access information has been updated at this time, using sound, light, vibration, or the like. This enables the user to be aware that a control operation corresponding to the GET button (a drag operation) has succeeded.

Then, in step S1060, remote control 400 determines whether or not processing should be continued, based on whether or not termination of processing has been directed by means of a user operation or the like, and terminates the series of processing steps if processing is not to be continued (S1060: NO), or returns to step S1000 if processing is to be continued (S1060: YES). A processing termination directive by means of a user operation is implemented, for example, by depression of a power button (not shown) provided on the external surface of the apparatus.

Next, if remote control 400 is directed toward television 300, for example, in step S1000 the IP address of television 300 is stored in active content holding section 440 by decoding section 460.

If the GET button has not been pressed (S1010: NO), in step S1070 PUT processing section 480 next determines whether or not the PUT button has been pressed—that is whether or not an execution trigger has been input from PUT button 420. If PUT button 420 has been pressed (S1070: YES), PUT processing section 480 proceeds to step S1080.

In step S1080, PUT processing section 480 determines whether or not a corresponding IP address has been acquired from active content holding section 440. If an IP address has been acquired (S1080: YES), PUT processing section 480 proceeds to step S1090. A corresponding IP address is the IP address of an Internet home appliance toward which remote control 400 was directed when PUT button 420 was pressed, or immediately before that.

In step S1090, PUT processing section 480 determines whether or not access information is being held in active content holding section 440, and if access information is being held (S1090: YES), proceeds to step S1100. If GET button 410 was pressed in a state in which remote control 400 was directed toward camera 200 immediately before PUT button 420 is pressed, this access information becomes a camera photograph list.

In step S1100, PUT processing section 480 transmits a POST request specifying access information held in active content holding section 440, with the IP address acquired in step S1080 as a destination. If PUT button 420 was pressed in a state in which remote control 400 was directed toward television 300, this POST request is an active content display request.

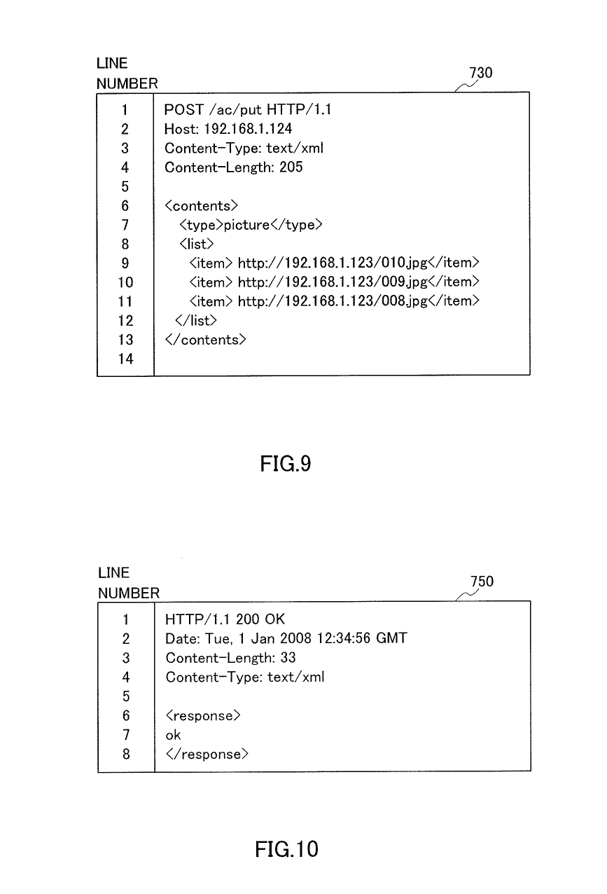

FIG. 9 is a drawing showing schematically an example of an active content display request.

As shown in FIG. 9, active content display request 730 is an HTTP POST request, and a URL for describing CGI 332 of television 300 is used for its destination path. That is to say, the specification of access information in a POST request for television 300 specifies activation of CGI 332. A photograph list acquired by means of the response shown in FIG. 8 is written in the body section (line numbers 6 through 13) of active content display request 730 as XML text.

An HTTP 200 OK response is sent back from television 300 in response to the POST request.

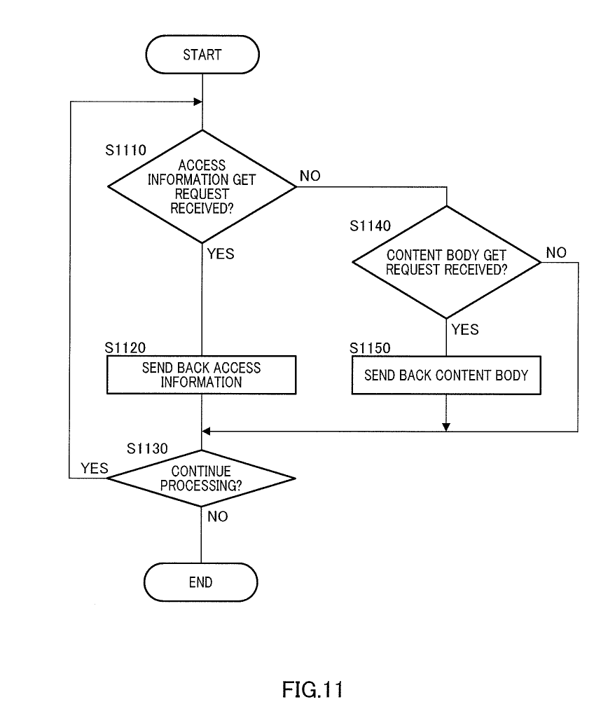

FIG. 10 is a drawing showing schematically an example of a response to the active content display request shown in FIG. 9. Response 750 to the active content display request, shown in FIG. 10, is an HTTP 200 OK response that gives notification of the fact that the request has been accepted.

After transmitting a POST request specifying access information, remote control 400 proceeds to step S1060 in FIG. 6. While neither GET button 410 nor PUT button 420 is pressed, the determination processing in steps S1000 through step S1070 is repeated until termination of processing is specified.

By means of such overall operation of remote control 400, the user can give directives to television 300 for acquisition and display of a camera 200 content body by operating remote control 400 with the same kind of sensation as a normal drag and drop operation.

It is desirable for a control operation to associate only a single immediately following depression of PUT button 420 with a GET button 410 depression. In this case, remote control 400 can delete or inhibit transmission of a transmitted photograph list at the time of active content display request transmission. Also, it is desirable for a control operation to associate only a single immediately following depression of GET button 410 with a PUT button 420 depression. In this case, remote control 400 can delete or inhibit transmission of an already held photograph list at the time of photograph list reception.

FIG. 11 is a flowchart showing remote control reception processing of camera 200.

First, in step S1110, HTTP server 231 of camera 200 determines whether or not a GET request specifying access information has been received, and proceeds to step S1120 if a GET request specifying access information has been received (S1110: YES). This GET request is an above-described active content acquisition request.

In step S1120, HTTP server 231 activates CGI 232, and sends back access information (a photograph list) generated by CGI 232 in response to the active content acquisition request.

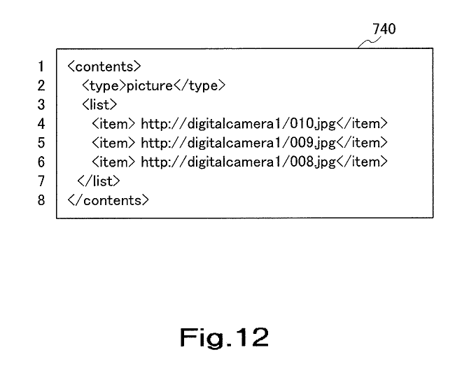

FIG. 12 is a drawing showing an example of the contents of a photograph list generated as access information by CGI 232.

As shown in FIG. 12, the essence of photograph list 740 generated by CGI 232 when represented and held in an XML (extensible markup language) format is memory or a file that can hold a character string. Here, the three character strings enclosed by “item” tags (line numbers 4 through 6) in photograph list 740 are URLs of photographic data held in camera 200. That is to say, the entirety of photograph list 740 represents three photographic data 221 URLs in list form.

Here, content named “010.jpg”, “009.jpg”, and “008.jpg” is listed.

HTTP server 231 generates the response shown in FIG. 8 by embedding photograph list 740 of this kind in the body section of a 200 OK response with the active content acquisition request sender (remote control 400) as a destination.

Then, in step S1130 in FIG. 11, HTTP server 231 determines whether or not processing should be continued, based on whether or not termination of processing has been directed by means of a user operation. HTTP server 231 terminates the series of processing steps if processing is not to be continued (S1130: NO), or returns to step S1110 if processing is to be continued (S1130: YES).

If a GET request specifying access information has not been received (S1110: NO), HTTP server 231 next determines in step S1140 whether or not a GET request specifying a content body has been received. This GET request is an above-described content transmission request. If a GET request specifying a content body has been received (S1110: YES), HTTP server 231 proceeds to step S1150.

In step S1150, HTTP server 231 sends back a requested content body in response to the content transmission request. If the URLs listed in photograph list 740 shown in FIG. 12 have been specified in the content transmission request, the three photographic data 221 items stored in photograph storage section 220 are transmitted. The order in which photographic data 221 is sent back in response to the content transmission request is the same as the normal order in which a Web browser acquires photographic data from an HTTP server.

After responding to a GET request specifying a content body, HTTP server 231 proceeds to step S1130. While HTTP server 231 receives neither an active content acquisition request nor a content transmission request, the determination processing in steps S1110 through step S1140 is repeated until termination of processing is specified.

By means of such remote control reception processing, camera 200 can send back access information (a photograph list) in accordance with a request from remote control 400, and send back a content body (photographic data) in accordance with a request from television 300.

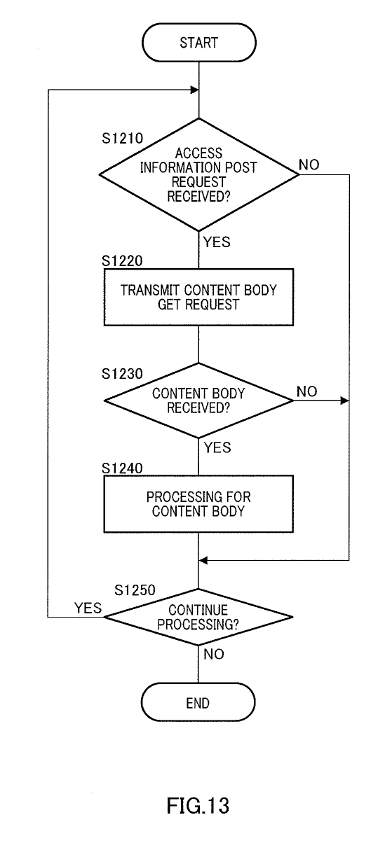

FIG. 13 is a flowchart showing remote control reception processing of television 300.

First, in step S1210, HTTP server 331 of television 300 determines whether or not a POST request specifying access information has been received, and proceeds to step S1220 if a POST request specifying access information has been received (S1210: YES). This POST request is an above-described active content display request. At this time, HTTP server 331 of television 300 sends back the response shown in FIG. 10.

In step S1220, HTTP server 331 of television 300 activates CGI 332, and as a result, a GET request specifying a content body is transmitted based on access information. If the received POST request includes a camera 200 photograph list as access information as shown in FIG. 9, this GET request is an above-described content transmission request.

Then, in step S1230, CGI 332 of television 300 determines whether or not a content body has been received in response to the GET request, and if a content body has been received (S1230: YES), proceeds to step S1240.

In step S1240, CGI 332 performs processing for the acquired content body. If the received POST request is the active content display request shown in FIG. 9, CGI 332 displays photographic data held by camera 200 on display 321 via graphic display section 325 and superimposition section 326.

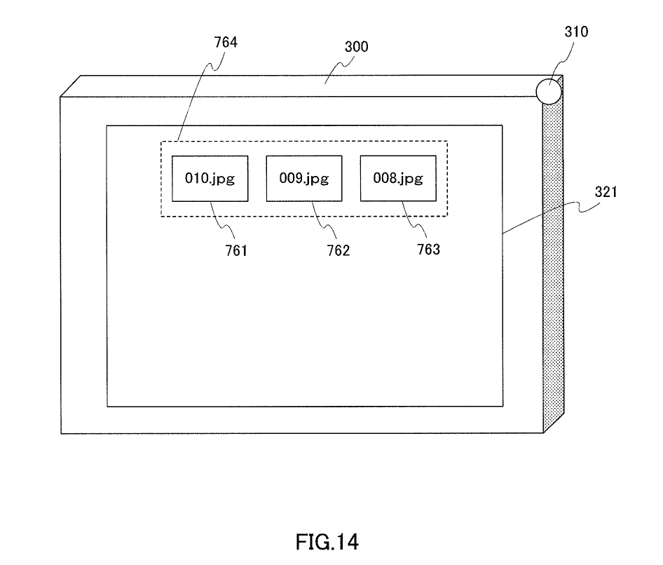

FIG. 14 is a perspective view showing an example of the appearance of television 300 on which camera 200 photographic data is displayed.

As shown in FIG. 14, a plurality of graphic objects 761 through 763 are displayed on display 321 of television 300. Graphic object is a generic term for an object that can be rendered in a graphic plane. That is to say, graphic objects have as subclasses photographic objects and photograph list objects, or a single photographic data item or photograph list. Graphic objects can be focused upon with a pointing device on an image-by-image basis, by means of television external input device 350 or the like.

Content body photograph list 764 listed in photograph list 740 shown in FIG. 12 is displayed on display 321 of television 300. To be more specific, graphic objects 761 through 763, which are reduced images of content bodies named “010.jpg”, “009.jpg”, and “008.jpg” respectively, are displayed as photograph list 764. That is to say, content bodies stored in camera 200 are not displayed one by one in their actual size on display 321, but instead, a plurality of these are displayed simultaneously in reduced size. Reduced images may be prepared for photograph list use by camera 200, or may be generated by size reduction by television 300. If reduced images are prepared by camera 200, it is further necessary for information relating to the whereabouts of full-size photographic data to be associated with these content bodies. For convenience of explanation, content names are shown in FIG. 14, but in actuality images that are display objects are displayed. Also, photograph list 764 is represented on the screen as an invisible transparent entity with a boundary.

Any photograph (content body) can be selected from displayed photograph list 764 by means of an external input device 350 control operation, and when a selection operation is performed, full-size photographic data for the selected photographic data is displayed on the screen.

Then, in step S1250 in FIG. 13, HTTP server 331 determines whether or not processing should be continued, based on whether or not termination of processing has been directed by means of a user operation. HTTP server 331 terminates the series of processing steps if processing is not to be continued (S1250: NO), or returns to step S1210 if processing is to be continued (S1250: YES).

By means of such remote control reception processing, television 300 can acquire, and display on its screen, photographic data held in camera 200 in accordance with a request from remote control 400.

In remote control system 100, the kind of remote control 400 operation described above enables a content body to be moved between Internet home appliances by a drag and drop operation by means of remote control 400 in real space. Also, content in accordance with the characteristics of a transmitting-side Internet home appliance can be made a movement target, as with photographic data captured by camera 200. Furthermore, a moved content body can be processed using a procedure in accordance with the characteristics of a receiving-side Internet home appliance, as with video display or image display in the case of television 300.

The overall operation of remote control system 100 will now be described, using an example of user operation.

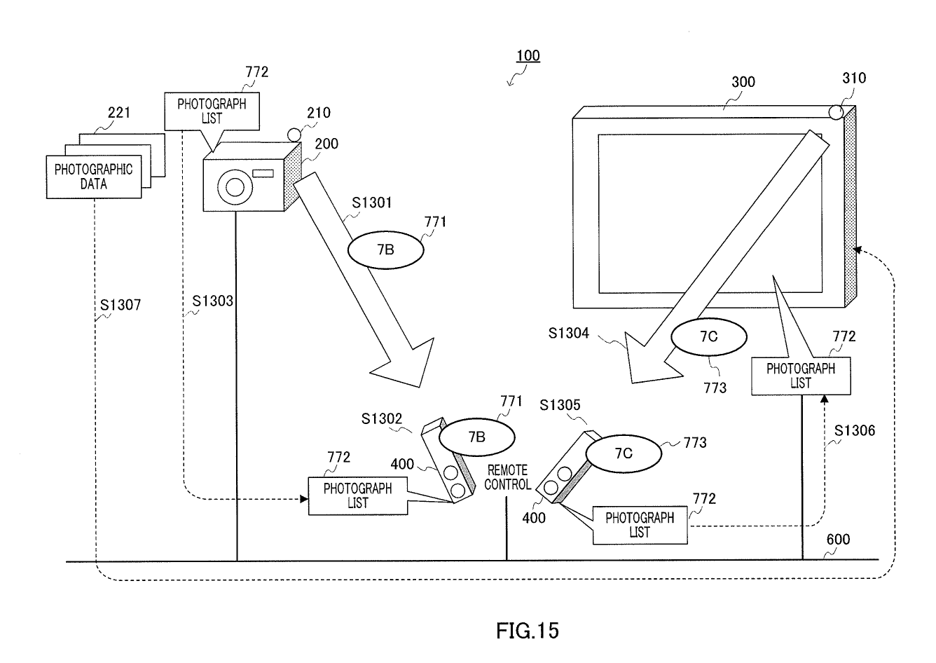

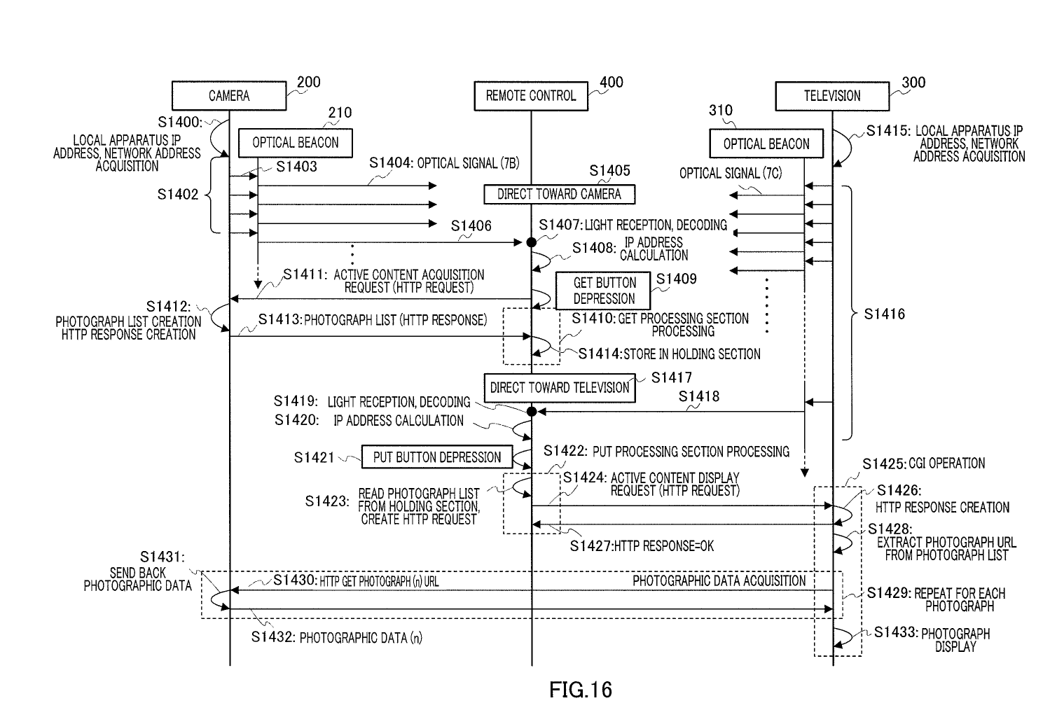

FIG. 15 is a drawing showing schematically an example of the overall operation of remote control system 100, and FIG. 16 is a sequence diagram of the overall operation shown in FIG. 15. Internal apparatus operations and data flows in remote control system 100 are described below using FIG. 15 and FIG. 16.

Here, the operation of remote control system 100 will be described for a case in which a user first presses the GET button with remote control 400 directed toward camera 200, and then presses the PUT button with remote control 400 directed toward television 300. That is to say, operation will be described for a case in which a user performs a drag and drop operation from camera 200 to television 300 using remote control 400.

First, in camera 200, optical beacon transmitting section 240 acquires network information held by network interface 230 (S1401). As a result, optical beacon transmitting section 240 recognizes that the IP address of its own apparatus is “192.168.1.123”, and the communication network 600 network mask is “255.255.255.0”. Then optical beacon transmitting section 240 periodically transmits self-identification information based on this recognition result (S1402). Specifically, optical beacon transmitting section 240 calculates that the host section of the IP address of its own apparatus is “123”, converts that host section value “123” to hexadecimal notation “7B”, and controls optical beacon 210 so as to transmit the two characters “7” and “B” (S1403). As a result, identification information “7B” 771 is periodically transmitted as a modulated wave from optical beacon 210 (S1301, S1404).

When remote control 400 is now directed toward camera 200 by the user (S1302, S1405), an optical signal output from optical beacon 210 of camera 200 reaches light receiving section 450 of remote control 400 (S1406). As a result, decoding section 460 performs decoding on the optical signal received by light receiving section 450, and acquires identification information “7B” 771 (S1407). Then decoding section 460 calculates the IP address of camera 200 from the decoded identification information, and stores the calculation result in active content holding section 440. Here, decoding section 460 calculates and stores IP address “192.168.1.123” of camera 200 in which the lowest octet of network address “192.168.1.0” has been replaced by “123”, the decimal equivalent of “7B” (S1408).

When GET button 410 of remote control 400 is now pressed by the user (S1409), GET processing section 470 starts the processing shown in FIG. 6 (S1410). GET processing section 470 transmits an active content acquisition request that is an HTTP request via communication network 600, with the last IP address decoded by decoding section 460 at that point in time (camera 200) as a destination (S1411). Then remote control 400 enters a state of waiting for a response to this request.

On receiving an active content acquisition request, HTTP server 231 of camera 200 activates CGI 232 and creates photograph list 772 and an HTTP response (S1412). Specifically, CGI 232 activated by HTTP server 231 lists URLs of photographic data 221 of photograph storage section 220 in photograph list 772, and writes photograph list 772 in the body section of the HTTP response. Then CGI 232 sends back photograph list 772 by means of the HTTP response to remote control 400 via communication network 600 (S1303, S1413).

On receiving the HTTP response, GET processing section 470 of remote control 400 stores photograph list 772 written in the body section of the HTTP response in active content holding section 440 as active content (S1414).

Meanwhile, in television 300, also, optical beacon transmitting section 340 acquires network information (S1415), and periodically transmits self-identification information based on the acquired network information (S1304, S1416). Specifically, optical beacon transmitting section 340 transmits identification information “7C” 773 representing host section “124” of the IP address of television 300 as a hexadecimal number from optical beacon 310.

When remote control 400 is now directed toward television 300 by the user (S1305, S1417), in a similar way to the case of camera 200, an optical signal output from optical beacon 310 of television 300 reaches light receiving section 450 of remote control 400 (S1310, S1418).

As a result, decoding section 460, in a similar way to the case of light reception from camera 200, decodes identification information “7C” 773 (S1419), calculates IP address “192.168.1.124” of television 300, and stores this IP address in active content holding section 440 (S1420).

When PUT button 420 of remote control 400 is now pressed by the user (S1421), PUT processing section 480 starts the processing shown in FIG. 6 (S1422). PUT processing section 480 first reads photograph list 772 from active content holding section 440, and generates an active content display request that is an HTTP request (S1423). Specifically, PUT processing section 480 writes photograph list 772 in the body section of an HTTP POST request. Then PUT processing section 480 transmits an active content display request that is an HTTP request via communication network 600, with the last IP address decoded by decoding section 460 at that point in time (television 300) as a destination (S1306, S1424). Then remote control 400 enters a state of waiting for a response to this request.

On receiving an active content display request, HTTP server 331 of television 300 activates CGI 332 and starts the CGI operation shown in FIG. 12 (S1425). In this CGI operation, CGI 332 activated by HTTP server 331 creates an HTTP response (S1426), and sends back the created HTTP response to remote control 400 (S1427). Specifically, before starting actual processing for an active content display request, CGI 332 assembles a 200 OK HTTP response, and sends this back to remote control 400. Sending back a response beforehand in this way enables remote control 400 to be released from the response standby state sooner.

Following this, CGI 332 acquires text data written in the body section of the active content display request, and determines the Type of content specified by that text data. Here, the content type is “picture”, as shown in FIG. 8. Therefore, CGI 332 determines that an object for which the active content display request requests display is a photograph list, and performs acquisition of photographic data for displaying photographs listed in that photograph list. This acquisition is performed by acquiring a photographic data URL from the photograph list (S1428), accessing the acquired URL, and repeating processing to acquire corresponding photographic data a number of times equivalent to the number of photographic data photographs (for example, n photographs) (S1429). Specifically, CGI 332 transmits an HTTP GET request to camera 200 via communication network 600 (S1430), and receives photographic data sent back from camera 200 (S1431) via communication network 600 (S1307, S1432).

Then CGI 332 displays acquired photographic data as graphic objects on display 321 of television 300 via graphic display section 325. At this time, CGI 332 stores URLs of graphic data that are the origin of the respective graphic objects, associated with the graphic objects. By this means, for example, when a graphic object is selected, various kinds of data corresponding to that selected graphic object can easily be displayed. Various kinds of data corresponding to a graphic object comprise, for example, original photographic data prior to reduction when photographic data is data in which certain photographic data has been reduced.

By means of such operation of remote control system 100, a user obtains a sensation of picking up active content by aiming at camera 200, and then dropping and displaying the active content by aiming at television 300.

As described above, according to this embodiment, remote control 400 has light receiving section 450 having directivity in a direction in which the body of remote control 400 is pointed. Then, when GET button 410 or PUT button 420 is pressed, and when an optical signal from an Internet home appliance is received by light receiving section 450, remote control 400 performs remote control of an Internet home appliance indicated by identification information included in that optical signal via communication network 600. By this means, remote control 400 can perform remote control of an Internet home appliance based on which Internet home appliance is specified by the user by pressing GET button 410 or PUT button 420. That is to say, a user can use remote control 400 as a pointing device in real space. Moreover, the above-described remote control can be performed without the need for installation of complex equipment or a display apparatus, or the task of recording Internet home appliances.

Also, processing by camera 200 when GET button 410 is pressed while remote control 400 is directed toward camera 200 is to send back a stored photographic data list to remote control 400 via remote control 400. And processing by television 300 when PUT button 420 is pressed while remote control 400 is directed toward television 300 is to acquire and display specified data. By this means, a user can copy photographic data stored in camera 200 and display that photographic data on the screen of television 300 by operating remote control 400 intuitively. That is to say, a user can instantly display photographic data stored in camera 200 on the large screen of television 300 by means of a simple control operation.

One important factor in popularizing Internet home appliances is the achievement of high operability. According to remote control system 100 of this embodiment, it is possible for a user to operate an Internet home appliance intuitively and fluently without the need to read a manual or learn mechanical control operations, which will encourage the popularization of Internet home appliances.

Also, it is desirable for a group of Internet home appliances having high operability to allow easy installation and setting by a user anywhere. Furthermore, even if a special apparatus is necessary to operate a group of Internet home appliances, it is desirable for that apparatus to be inexpensive and readily obtainable. According to remote control system 100 of this embodiment, there is no need for a special apparatus or special software, enabling market requirements to be met, and the popularization of Internet home appliances to be further encouraged.

Moreover, according to remote control system 100 of this embodiment, setting can be performed on the Internet home appliance side as to what kind of access information is to be sent back, with what as a content body, when an active content acquisition request is received. Also, according to remote control system 100 of this embodiment, setting can be performed on the Internet home appliance side as to what kind of processing is to be performed on an acquired content body when an active content display request is received. Therefore, contents of possible remote control by remote control 400 can be set in line with the characteristics of an Internet home appliance, according to circumstances, or in accordance with the intentions of an Internet home appliance manufacturer. For example, if a display apparatus with a low-capability display device receives a POST request specifying large-size photographic data, it is possible for processing to be selected that performs storage in an internal storage medium rather than performing display.

### Embodiment 2

As Embodiment 2 of the present invention, a remote control system will be described in which it is possible for an image displayed on a television screen to be stored in a recording medium of a camera.

In a remote control system according to Embodiment 2, a remote control of Embodiment 1 is also used as an external input device of a television. Also, the CGI functions of a camera and television of Embodiment 1 are extended, and it is possible for an image specified by a remote control functioning as an external input device from among images displayed on a television to be dragged and dropped to a camera.

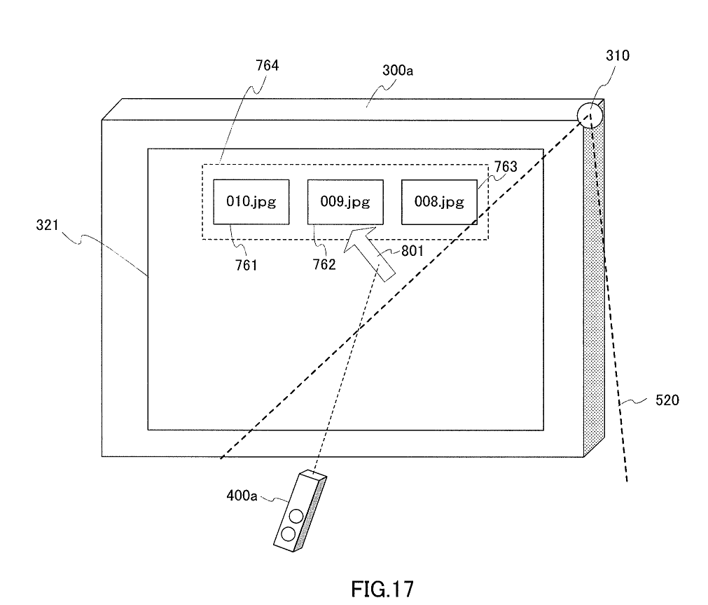

FIG. 17 is a drawing showing the nature of image selection in a television of a remote control system according to this embodiment.

As shown in FIG. 17, in this embodiment, remote control 400a can move cursor 801 on the screen of display 321 of television 300a. Also, remote control 400a can point to any object among graphic objects 761 through 763 displayed on the screen by means of cursor 801, and furthermore can perform various kinds of control operations on an object being pointed to.

Cursor 801 moving and pointing operations are performed, for example, by providing arrow keys or suchlike direction keys and a selection key on remote control 400a, and transmitting information indicating control operation contents from remote control 400a to television 300a via communication network 600. Also, for example, television 300a may be provided with a detection apparatus for detecting which position on its own screen remote control 400a is directed toward, and whether or not a selection operation has been performed, and detection results of this detection apparatus may be used. Here, a case will be described in which arrow keys or suchlike direction keys and a selection key are provided on remote control 400a.

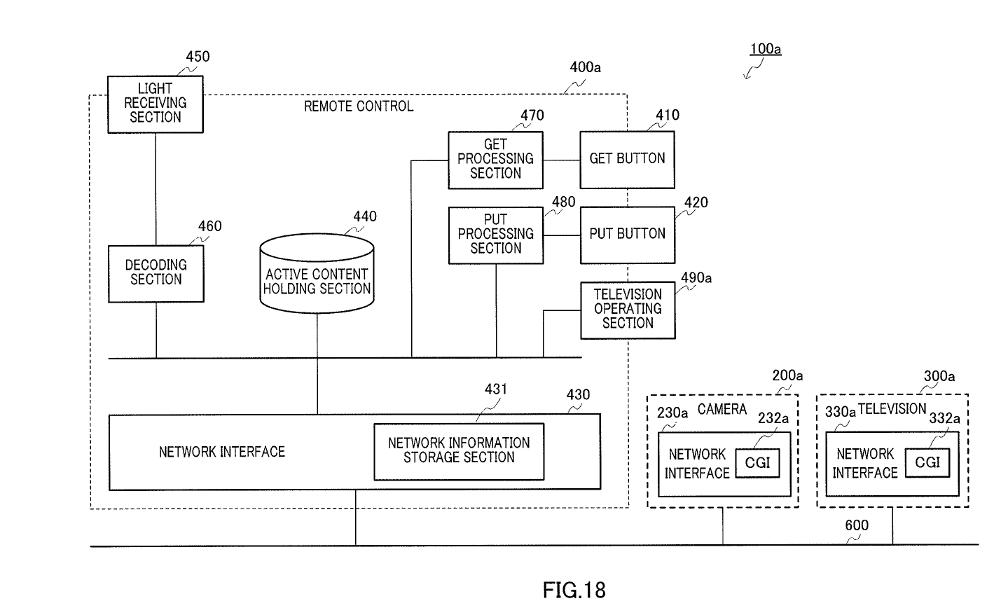

FIG. 18 is a block diagram showing the configuration of remote control 400a, and corresponds to FIG. 2 of Embodiment 1. Parts identical to those in FIG. 2 are assigned the same reference codes as in FIG. 2, and descriptions thereof are omitted here. FIG. 18 also shows configuration parts of camera 200a and television 300a that differ from the configurations in Embodiment 1.

As shown in FIG. 18, remote control 400a has television operating section 490a. Television operating section 490a has an operating section and an information transmitting section (neither of which is shown). The operating section has arrow keys functioning as direction keys on the external surface of the apparatus. Each time a control operation is performed by the operating section, the information transmitting section transmits information indicating the contents of that control operation to television 300a via network interface 430 and communication network 600. Television operating section 490a is included in external input device 350 shown in FIG. 5 of Embodiment 1.

Television 300a and camera 200a have network interfaces 330a and 230a instead of network interfaces 330 and 230 of Embodiment 1. Instead of CGIs 332 and 232, network interfaces 330a and 230a have CGIs 332a and 232a respectively that implement remote control reception processing with different contents from CGIs 332 and 232. Only television 300a remote control reception processing and camera 200a remote control reception processing will be described below.

Television 300a holds digital data of photographs being displayed (hereinafter referred to as “photographic data”) as content bodies. Also, television 300a generates content body URLs (hereinafter referred to for convenience as “photograph URLs”) as access information for accessing these content bodies.

On receiving an HTTP GET request via the communication network, television 300a sends back the specified information. At this time, television 300a sends back access information (here, a photograph URL) if access information is specified, or sends back a specified content body if a content body is specified.

On receiving an HTTP POST request via communication network 600, camera 200a acquires the specified information. At this time, if access information is specified, camera 200a accesses a content body held in another Internet home appliance based on the access information. If the access information is an above-described photograph URL, camera 200a acquires photographic data corresponding to the photograph URL from television 300a by transmitting a GET request specifying that photograph URL. Then camera 200a records the acquired photographic data in photograph storage section 220.

Below, for convenience, a GET request specifying access information, transmitted from remote control 400a to television 300a, is referred to as an “active content acquisition request”. Also, a POST request specifying a television 300a photograph URL, transmitted from remote control 400a to camera 200a, is referred to as an “active content recording request”. Furthermore, a GET request specifying a television 300a content body, transmitted from camera 200a to television 300a, is referred to as a “content transmission request”.

In format, an “active content recording request” is identical to an “active content display request” of Embodiment 1. As described above, interpretation and processing for an HTTP request specifying active content can be contrived arbitrarily in line with the characteristics of an Internet home appliance. Therefore, even with the same POST request, its function differs according to the receiving-side Internet home appliance.

In this embodiment, camera 200a has been contrived beforehand so as to perform recording in its own internal memory rather than screen display on receiving an HTTP request (POST request) having the same format as an “active content display request”. Therefore, in this embodiment, for convenience of explanation, a POST request having the same format as an “active content display request” transmitted to camera 200a is referred to as an “active content recording request”.

With regard to remote control reception processing executed by camera 200a and remote control reception processing executed by television 300a, a held content body, generated access information, and processing for an acquired content body are different, but other processing is common. Thus, remote control reception processing by camera 200a and television 300a is described here as processing common to the HTTP servers of all Internet home appliances.

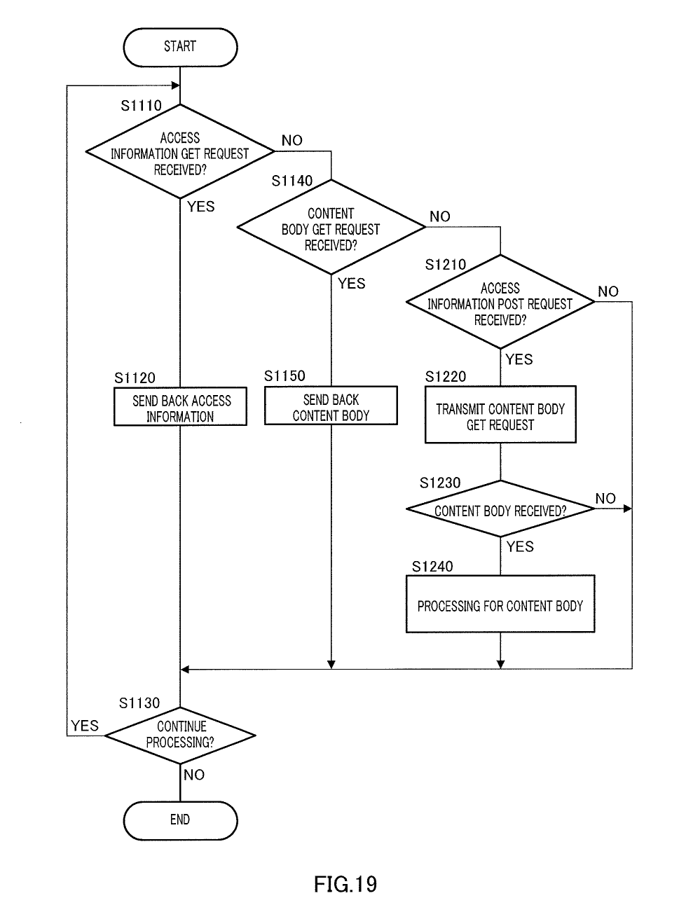

FIG. 19 is a flowchart showing remote control reception processing of an Internet home appliance, and corresponds to FIG. 11 and FIG. 13 of Embodiment 1. Parts identical to those in FIG. 11 and FIG. 13 are assigned the same reference codes as in FIG. 11 and FIG. 13, and descriptions thereof are omitted here.

An Internet home appliance HTTP server repeatedly determines whether or not a GET request specifying access information has been received (S1110), whether or not a GET request specifying a content body has been received (S1140), and whether or not a POST request specifying access information has been received (S1210). Then if any HTTP request has been received, the HTTP server performs corresponding processing shown in FIG. 11 and FIG. 12.

However, there are the following differences between television 300a processing and camera 200a processing.

In step S1120, CGI 332a of television 300a decides a content body that is a movement target, and sends back a URL (photograph URL) of the decided content body (photograph list). Specifically, CGI 332a determines which photographic data has been selected from photographic data displayed on the screen, based on the contents of a user operation interpreted by interpretation section 328, and decides on the selected photographic data as a movement target. Then CGI 332a sends back the URL of the decided photographic data to remote control 400a.

Also, if a GET request specifying a content body has been received (S1140: YES), CGI 332a of television 300a sends back the specified content body in step S1150.

On the other hand, if a POST request specifying access information has been received (S1210: YES), CGI 232a of camera 200a transmits a GET request specifying a content body, based on the access information (S1220). Then, on receiving a content body (S1230: YES), if the received POST request is an active content recording request, CGI 232a records photographic data selected by the user from the photographic data displayed by television 300a in photograph recording section 220. CGI 232a determines whether or not a content body specified by the POST request can be recorded based on whether or not the content body is represented in a specific data format, for example.

By means of such remote control reception processing, television 300a can send back access information (a photograph URL) in accordance with a request from remote control 400a, and send back a content body (photographic data) in accordance with a request from camera 200a. Also, camera 200a can record photographic data displayed by television 300a in photograph storage section 220 in accordance with a request from remote control 400a. Moreover, it is possible for only a URL of photographic data selected by means of a remote control 400a operation from photographic data being displayed on television 300a to be recorded in camera 200a.

The overall operation of remote control system 100a will now be described, using an example of user operation.

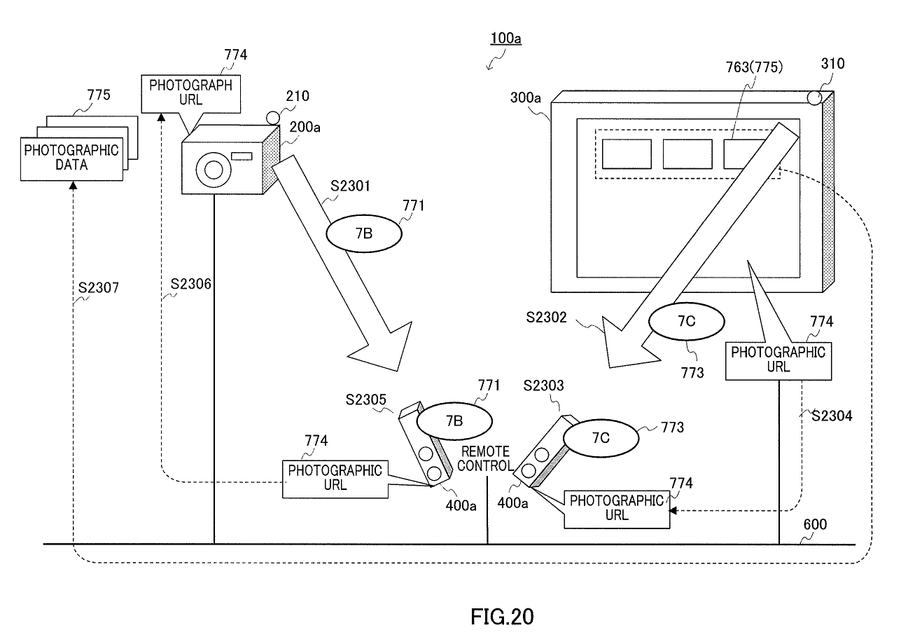

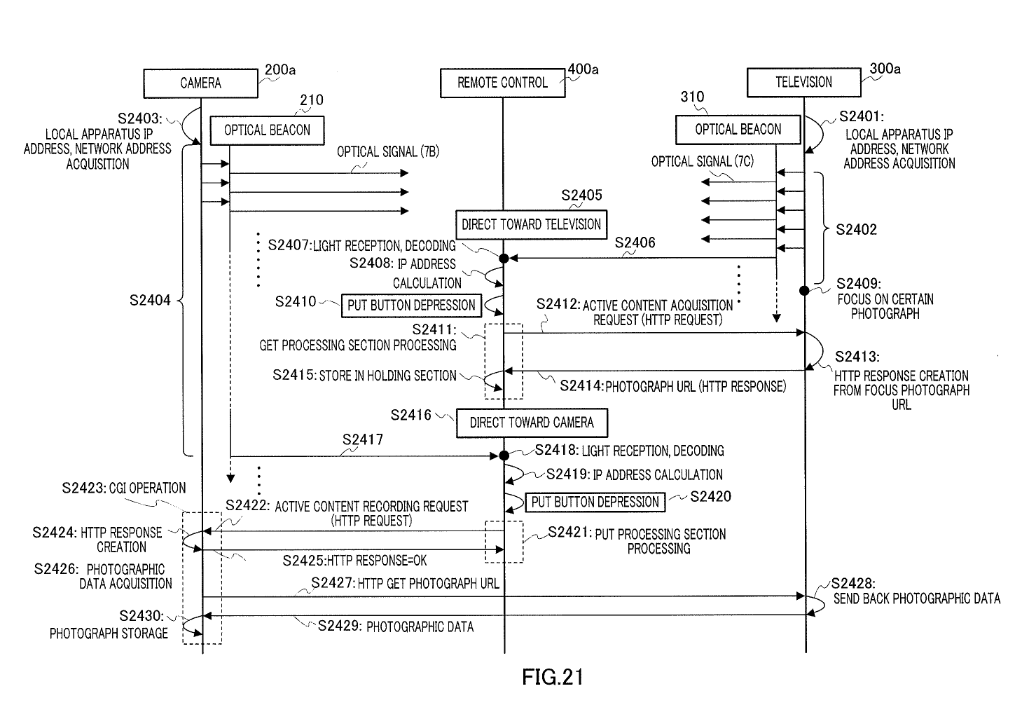

FIG. 20 is a drawing showing schematically an example of the overall operation of remote control system 100a, and FIG. 21 is a sequence diagram of an example of the overall operation shown in FIG. 20. Internal apparatus operations and data flows in remote control system 100 are described below using FIG. 20 and FIG. 21.

Here, the operation of remote control system 100a will be described for a case in which a user first presses the GET button with remote control 400a directed toward television 300a on which a plurality of photographic data are being displayed, and then presses the PUT button with remote control 400a directed toward camera 200a. That is to say, operation will be described for a case in which a user performs a drag and drop operation from television 300a to camera 200a using remote control 400a.

First, in television 300a, in a similar way to Embodiment 1, optical beacon transmitting section 340 acquires its apparatus's own IP address and network address (S2401), and periodically transmits self-identification information “7C” 771 by means of an optical signal from optical beacon 310 (S2301, S2402). In camera 200a, also, in a similar way to Embodiment 1, optical beacon transmitting section 240 acquires its apparatus's own IP address and network address (S2403), and periodically transmits self-identification information “7B” 771 by means of an optical signal from optical beacon 210 (S2302, S2404).

When remote control 400a is now directed toward television 300a by the user (S2303, S2405), a television 300a optical signal reaches light receiving section 450 of remote control 400, and optical signal decoding and IP address calculation are performed by remote control 400a (S2407, S2408).

Here, it is assumed that a photograph on the screen of television 300a is focused upon through use of remote control 400a by the user.

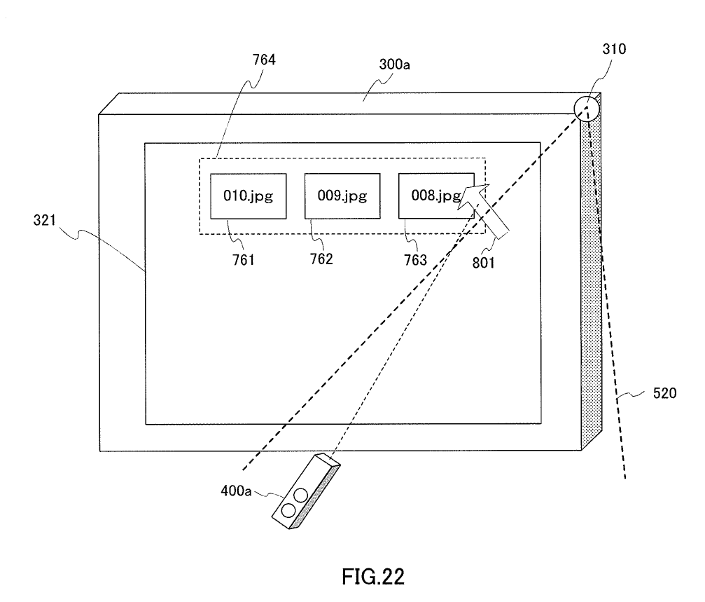

FIG. 22 is a drawing showing how a photograph on television 300a is focused upon.

As shown in FIG. 22, it is assumed here that a decision operation is performed in a state in which cursor 801 is pointed at graphic object 763 (with a heavy-line frame displayed, for example). That is to say, the focus is assumed to be on photographic data 775 “008.jpg” corresponding to graphic object 763.

Assume that GET button 410 of remote control 400a is pressed (S2410) in the state shown in FIG. 22—that is, a state in which the focus is on photographic data 775—(S2409). In this case, GET processing section 470 starts the processing shown in FIG. 6 (S2411), and after transmitting an active content acquisition request to television 300a (S2412), enters a state of waiting for a response to this request.

On receiving an active content acquisition request, HTTP server 331 of network interface 330 activates CGI 232a and creates an HTTP response based on photograph URL 774 (S2413). Specifically, CGI 332a identifies photographic data selected by means of a remote control 400a operation, and writes the URL of the identified photographic data (here, the URL of photographic data 775) in the body section of the HTTP response. Then CGI 332a sends back photograph URL 774 by means of the HTTP response to remote control 400a via communication network 600 (S2304, S2414).

On receiving the HTTP response, GET processing section 470 stores the photograph URL written in this body section in active content holding section 440 (S2415).

When remote control 400a is now directed toward camera 200a by the user (S2305, S2416), a camera 200a optical signal reaches light receiving section 450 of remote control 400a (S2417), and optical signal decoding and IP address calculation are performed by remote control 400a (S2418, S2419).

Assume that PUT button 420 of remote control 400a is now pressed by the user (S2420). PUT processing section 480 then starts the processing shown in FIG. 6 (S2421), and after transmitting an active content recording request to camera 200a (S2306, S2422), enters a state of waiting for a response to this request.

On receiving an active content recording request, HTTP server 231 of camera 200a activates CGI 232a and creates an HTTP response (S1424). Specifically, before starting actual processing for an active content recording request, CGI 232a creates a 200 OK HTTP response, and sends this back to remote control 400a (S2425).

Following this, CGI 232a of camera 200a starts the processing shown in FIG. 19 (S2423). CGI 232a activates CGI 232a and starts the processing shown in FIG. 19 (S2423). In this CGI operation, CGI 232a creates an HTTP response (S2424), and sends back the created HTTP response to remote control 400a. Then CGI 232a of camera 200a acquires text data written in the body section of the active content recording request, and performs photographic data acquisition based on the written content type and photograph URL (S2426). Specifically, CGI 232a transmits an HTTP GET request to television 300a via communication network 600 (S2427). Then CGI 232a receives photographic data sent back from television 300a (S2428) via communication network 600 (S2307, S2429).

Then CGI 232a stores the acquired photographic data in photograph storage section 220 of camera 200a (S2430).

By means of such operation of remote control system 100a, a user obtains a sensation of picking up active content by aiming at television 300a, and then dropping and recording the active content by aiming at camera 200a.

Thus, according to this embodiment, processing by television 300a when GET button 410 is pressed while remote control 400a is directed toward television 300a is to send back to remote control 400 a URL of photographic data selected by means of a user operation from photographic data being displayed. Also, processing by camera 200a when PUT button 420 is pressed while remote control 400 is directed toward camera 200a is to acquire and record photographic data for a specified URL. By this means, a user can hold photographic data from the screen of television 300a in an internal recording medium of camera 200a by operating remote control 400a intuitively. That is to say, a user can instantly copy desired photographic data on the screen of television 300a, and hold that photographic data in a camera 200a recording medium, by means of a simple control operation. Also, holding photographic data in an Internet home appliance that has portability, such as camera 200a, enables a state in which photographic data can be taken out to be established easily.

### Embodiment 3

As Embodiment 3 of the present invention, a remote control system will be described in which it is possible to operate an air conditioner via a television screen.

In a remote control system according to Embodiment 3, a remote control also functions as a television external input device, as in Embodiment 2. Also, remote control system 100a according to Embodiment 2 has been given a configuration in which camera 200a according to Embodiment 2 is replaced by an air conditioner as an Internet home appliance. Most of the configuration relating to remote control of an air conditioner is common to camera 200a. Thus, a description of the common parts is omitted here, and air conditioner parts in the following drawings that are common to a camera are assigned the same reference codes as in a camera.

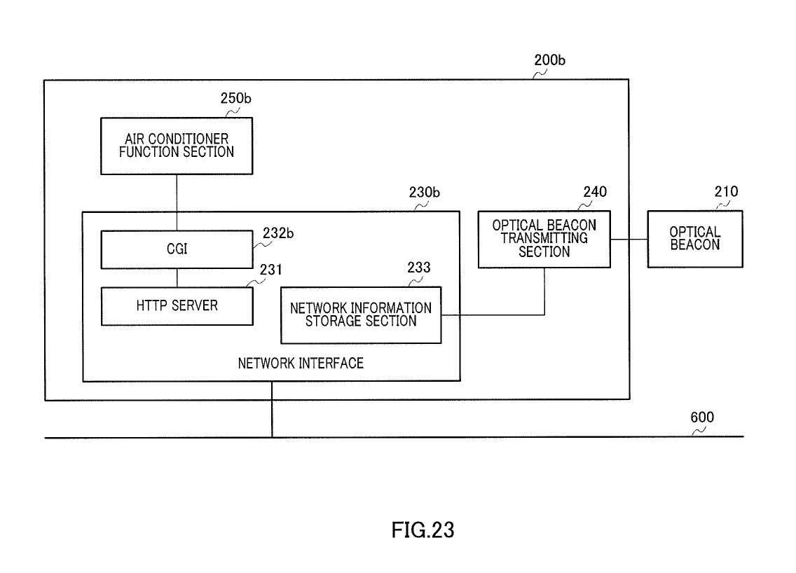

FIG. 23 is a block diagram showing the configuration of an air conditioner, and corresponds to FIG. 4 of Embodiment 1.

As shown in FIG. 23, air conditioner 200b has air conditioner function section 250b that performs air conditioning. Air conditioner 200b has network interface 230b instead of network interface 230 shown in FIG. 4. Instead of CGI 232 of camera 200 shown in FIG. 4, this network interface 230b has CGI 232b that implements remote control reception processing with different contents from CGI 232.

CGI 232b is a CGI that is called and activated when HTTP server 231 receives an active content acquisition request—that is, a GET request specifying access information. CGI 232b stores a user interface (UI) for operating air conditioner function section 250b via the screen of a display or the like as a content body. For the operating user interface here, a air conditioner function section 250b operating function, operating range, and so forth, are extracted from the GUI operating screen, omitting layout information and the like, and the extracted contents are described by means of XML.

In this embodiment, in order to simplify the description, XML text will be assumed in which a “function for displaying the current room temperature” and a “function for selecting an operating mode” are described. By accessing the URL of this operating user interface, it is possible to display the current room temperature or change the operating mode of air conditioner 200b on the screen of another Internet home appliance.

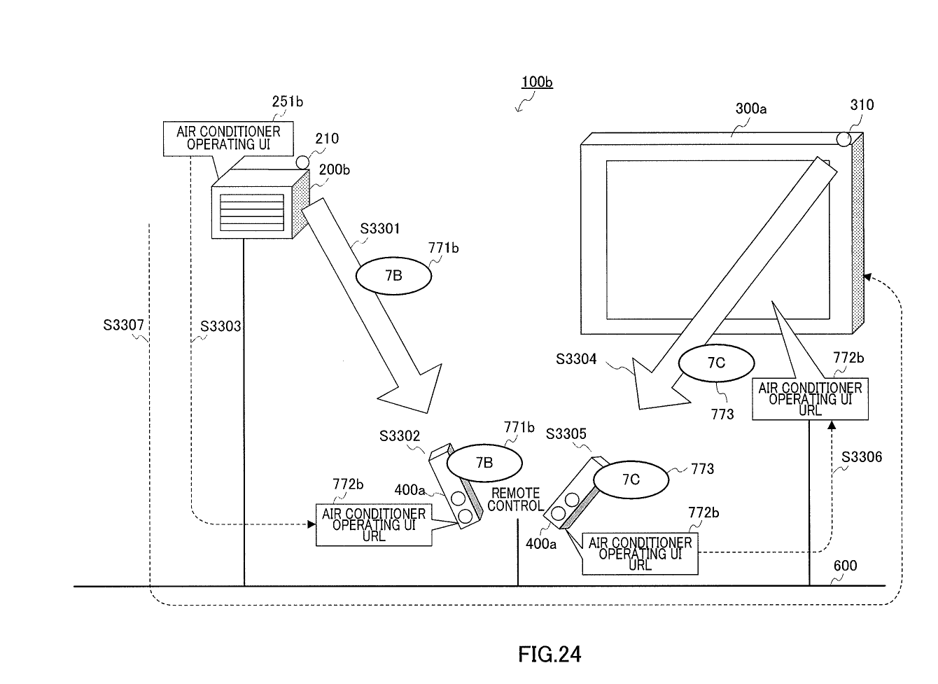

FIG. 24 is a drawing showing schematically an example of the overall operation of a remote control system according to this embodiment.

In remote control system 100b, it is assumed that “192.168.1.125” is stored in network information storage section 233 of air conditioner 200b as the IP address of the apparatus. In this case, air conditioner 200b periodically transmits identification information “7D”, which is the lowest octet of this IP address, by means of an optical signal (S3301).

When the user now directs remote control 400a toward air conditioner 200b (S3302) and presses GET button 410 of remote control 400a, remote control 400a transmits an active content acquisition request to air conditioner 200b via communication network 600. In response to this, CGI 232b of remote control 400a sends back URL 772b of operating user interface 251b as access information (S3303).

Assume that identification information “7C” is periodically transmitted from television 300a (S3304), and the user directs remote control 400a toward television 300a (S3305) and presses PUT button 420 of remote control 400a. In this case, remote control 400a transmits an active content display request including access information (URL 772b of operating user interface 251b) acquired from air conditioner 200b to television 300a via communication network 600 (S3306).

Television 300a acquires operating user interface 251b of air conditioner 200b based on operating user interface URL 772b included in the received active content display request, and displays an operating screen for air conditioner 200b (S3307).

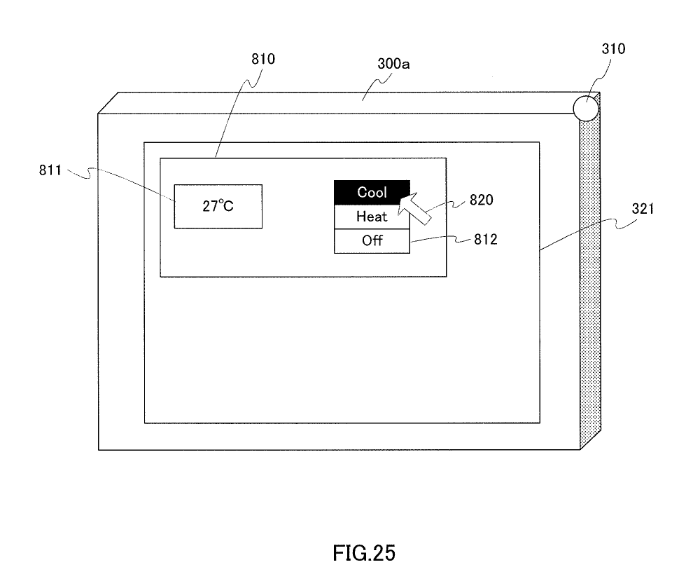

FIG. 25 is a perspective view showing an example of the appearance of television 300a on which an air conditioner 200b operating screen is displayed.

As shown in FIG. 25, operating screen 810 for air conditioner 200b is displayed on display 321 of television 300a. Operating screen 810 has area 811 displaying the current room temperature and area 812 displaying an operating mode selection button. Various kinds of control operations can be performed on air conditioner 200b by moving cursor 820 in operating screen 810 and selecting a desired operating mode or the like.

By means of such operation of remote control system 100b, a user obtains a sensation of picking up active content by aiming at air conditioner 200b, and then dropping and displaying the active content by aiming at television 300.

Thus, according to this embodiment, processing by air conditioner 200b when GET button 410 is pressed while remote control 400a is directed toward air conditioner 200b is to send back to remote control 400a a URL of a control interface of air conditioner functions of air conditioner 200b via communication network 600. By this means, a user can display a screen for performing air conditioner 200b control operations and information display on the large screen of television 300a by operating remote control 400a intuitively. A user can then perform an air conditioner 200b control operation such as selection of a preferred operating mode via the screen of television 300a.

Unlike AV (audiovisual) devices such as cameras and televisions, so-called white goods such as air conditioners and cooking appliances do not normally hold content for viewing or listening, such as video, photographs, music, and the like, but do have an operating interface of some kind. According to this embodiment, making this operating interface a target of a drag and drop operation enables more versatile remote control employing a rich user interface such as a television to be implemented.

### Embodiment 4

As Embodiment 4 of the present invention, a remote control system will be described in which a graphic object is shared with a communicating party on the screen of a so-called videophone, and a drag and drop operation in real space can be performed on this graphic object.

In a remote control system according to Embodiment 4, a configuration is used in which television 300a according to Embodiment 2 is replaced by a videophone as an Internet home appliance. Most of the configuration relating to video display and control operations on the display contents of this videophone are common to television 300a, and provision is made for user operations to be received by means of an external input device. In this embodiment, in a similar way to Embodiment 2, it is assumed that a remote control is also used as an external input device of a videophone.

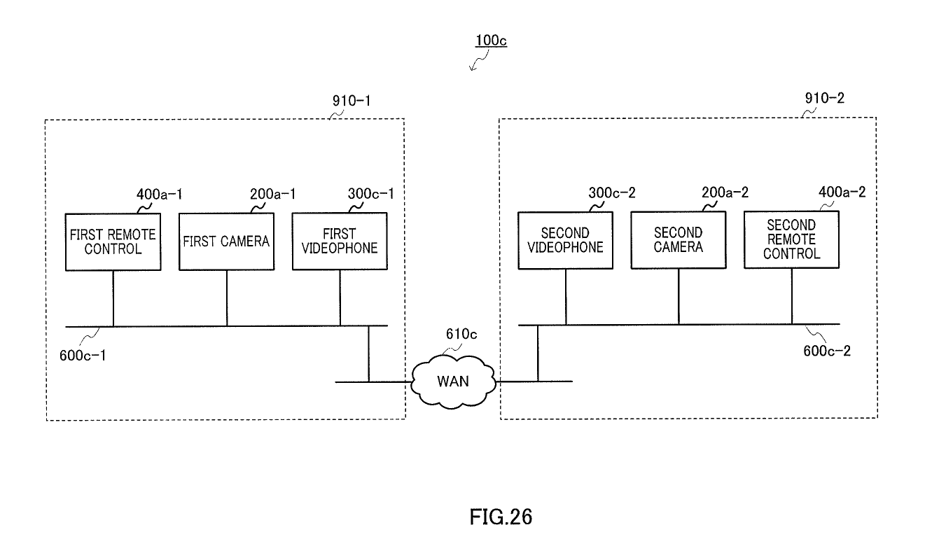

FIG. 26 is a system configuration diagram showing the configuration of a remote control system according to Embodiment 4.

In FIG. 26, remote control system 100c is constructed spanning mutually separated first room 910-1 and second room 910-2. Remote control system 100c has first LAN (local area network) 600c-1, second LAN 600c-2, and WAN (wide area network) 610c. First LAN 600c-1 is installed in first room 910-1, and second LAN 600c-2 is installed in second room 910-2. WAN 610c is an IP network—for example, the Internet. Although first LAN 600c-1 and second LAN 600c-2 are physically separate, they are logically connected via WAN 610c, and can freely access each other.

Connected to first LAN 600c-1 are first remote control 400a-1 and first camera 200a-2 according to Embodiment 2, and first videophone 300c-1. Connected to second LAN 600c-2 are second remote control 400a-2 and second camera 200a-2 according to Embodiment 2, and second videophone 300c-2.

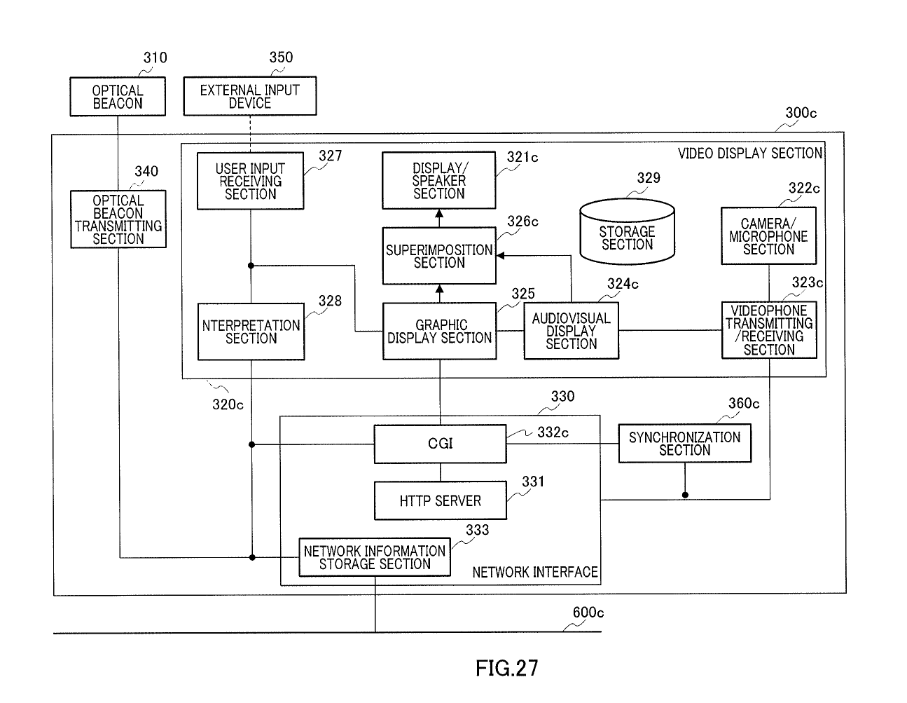

FIG. 27 is a block diagram showing the configuration of videophone 300c, and corresponds to FIG. 5 of Embodiment 1. Parts identical to those in FIG. 5 are assigned the same reference codes as in FIG. 5, and descriptions thereof are omitted here.

As shown in FIG. 27, videophone 300c has videophone section 320c and network interface 330c instead of video display section 320 and network interface 330 in FIG. 5. Also, videophone 300c has synchronization section 360c.

Instead of display 321, tuner 322, video input section 323, moving image display section 324, and superimposition section 326 in FIG. 5, videophone section 320c has display/speaker section 321c, camera/microphone section 322c, videophone transmitting/receiving section 323c, audiovisual display section 324c, and superimposition section 326c.

Display/speaker section 321c has, for example, a liquid crystal display panel and loudspeaker (not shown), and performs video display and speech output.

Camera/microphone section 322c has a digital TV camera and microphone, and inputs a user's speech for a call, and also captures video of a user during a call.

Videophone transmitting/receiving section 323c establishes IP videophone communication with a communicating-party videophone connected via network interface 330c. Following this, videophone transmitting/receiving section 323c transmits speech and video input by means of camera/microphone section 322c to the communicating-party videophone (hereinafter referred to as “communicating party”) with which telephone communication has been established, and also receives speech and video from the communicating party.

Audiovisual display section 324c outputs speech and video received from the communicating party by videophone transmitting/receiving section 323c from display/speaker section 321c.

Superimposition section 326c displays an image drawn by graphic display section 325 on display/speaker section 321c, superimposed on video output by audiovisual display section 324c.

Instead of CGI 332 in FIG. 5, network interface 330c has CGI 332c that implements remote control reception processing with different contents from CGI 332.

In addition to the function of CGI 332a shown in FIG. 18 of Embodiment 2, CGI 332c has a function of performing synchronization of graphic object display with a communicating party, using synchronization section 360c described later herein.

Synchronization section 360c performs synchronization of graphic object display with a communicating party. Specifically, synchronization section 360c causes display of the same content body by its own apparatus and a communicating party by copying an active content display request received by its own apparatus and transmitting this active content display request to the communicating party. Also, synchronization section 360c shares control operation contents for a graphic object displayed by its own apparatus or the communicating party, and applies the same change to graphic object display contents.

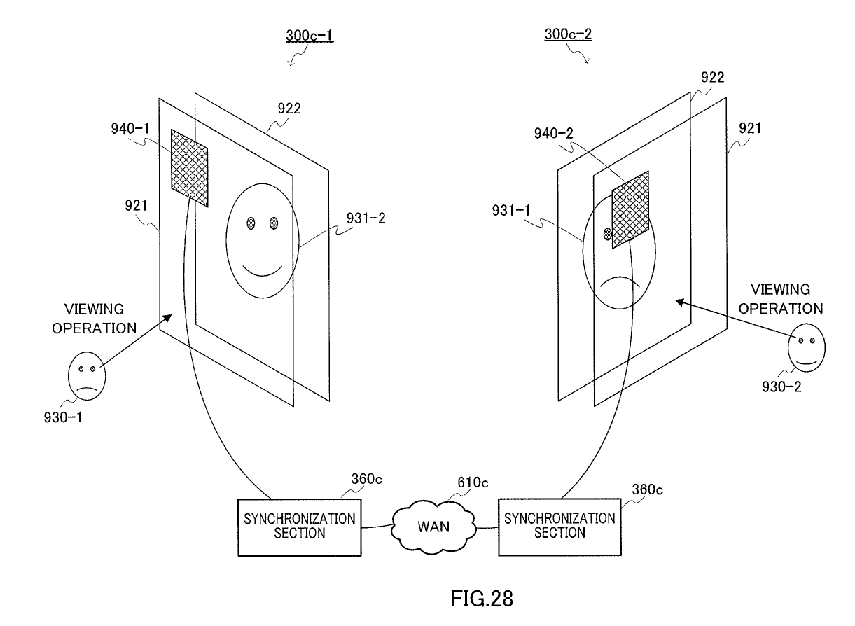

FIG. 28 is a drawing showing schematically how synchronization of graphic object display is performed by synchronization sections 360c.

As shown in FIG. 28, first and second videophones 300c-1 and 300c-2 each have graphic plane 921 and moving image plane 922 as drawing planes. Graphic plane 921 is a drawing plane for drawing performed by graphic display section 325. Moving image plane 922 is a drawing plane for drawing by audiovisual display section 324c of video received from a communicating party. Superimposition section 326c displays images of these two drawing planes on display/speaker section 321c in a superimposed fashion.

Video 931-1 of first user 930-1 using first videophone 300c-1 is displayed on moving image plane 922 of second videophone 300c-2. Video 931-2 of second user 930-2 using second videophone 300c-2 is displayed on moving image plane 922 of first videophone 300c-1.

Assume that an active content display request from first remote control 400a-1 reaches first videophone 300c-1, and first graphic object 940-1 is displayed on graphic plane 921 of first videophone 300c-1. At this time, synchronization section 360c of first videophone 300c-1 transfers the active content display request to second videophone 300c-2 via WAN 610c. On receiving the active content display request, second videophone 300c-2 acquires a content body in the same way as first videophone 300c-1. Then second videophone 300c-2 draws second graphic object 940-2, which is the same image as first graphic object 940-1, on its own graphic plane 921 at the same relative position and size.

Each time a user operation of some kind is performed on graphic object 940 displayed based on an active content display request, synchronization section 360c of first or second videophone 300c-1 or 300c-2 notifies synchronization section 360c of the communicating party of the contents of that control operation. Synchronization section 360c notified of the control operation contents by the communicating party implements those control operation contents by means of CGI 332c in the same apparatus. The operation contents include, for example, movement, display size change, iconization and deletion. As a result, first and second graphic objects 940-1 and 940-2 displayed by first and second videophones 300c-1 and 300c-2 are kept in an identical state, and are displayed at the same position and size. Therefore, close communication can be performed between first user 930-1 and second user 930-2, just like communication through a single pane of glass.

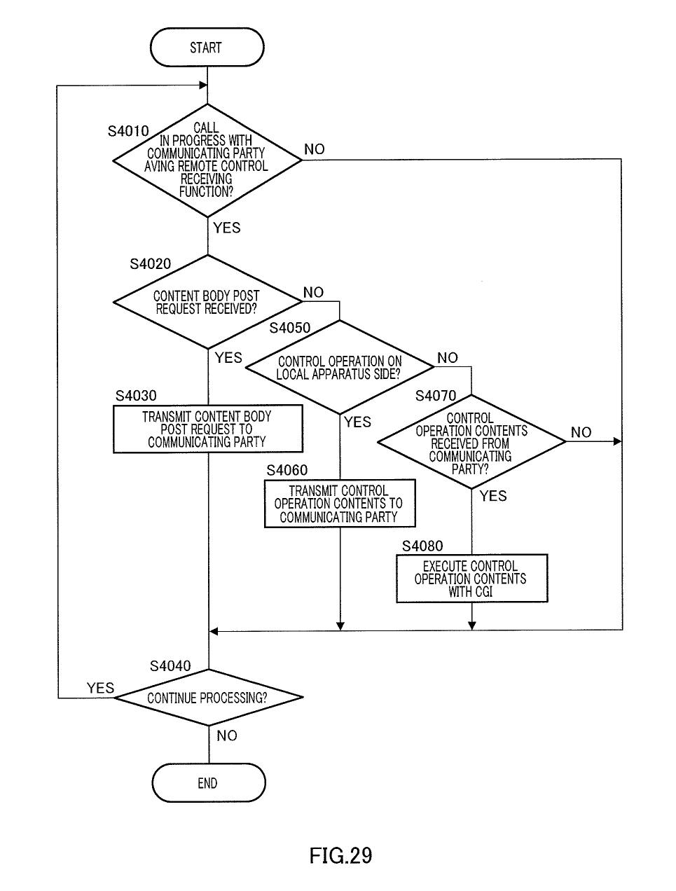

FIG. 29 is a flowchart showing the operation of synchronization section 360c.

First, in step S4010, synchronization section 360c determines whether or not a call is being performed with a communicating party having a remote control receiving function (here, videophone 300c according to this embodiment). If a call is in progress (S4010: YES), synchronization section 360c proceeds to step S4020.

In step S4020, synchronization section 360c determines whether or not a POST request specifying a content body has been received from an Internet home appliance other than the communicating party. Provision may be made for this determination to be performed by CGI 332c, and for the determination result to be passed to synchronization section 360c. If a POST request specifying a content body has been received from an Internet home appliance other than the communicating party (S4020: YES), synchronization section 360c proceeds to step S4030.

In step S4030, synchronization section 360c generates a POST request specifying the same content body, based on the received POST request, and transmits this POST request to the communicating party via WAN 610c. Provision may be made to have this POST request generation performed by CGI 332c. If PUT button 420 is pressed in a state in which remote control 400a is directed toward videophone 300c, this POST request becomes an active content display request. An active content display request generated here includes information for recognition by the communicating party that this is an active content display request from that apparatus.

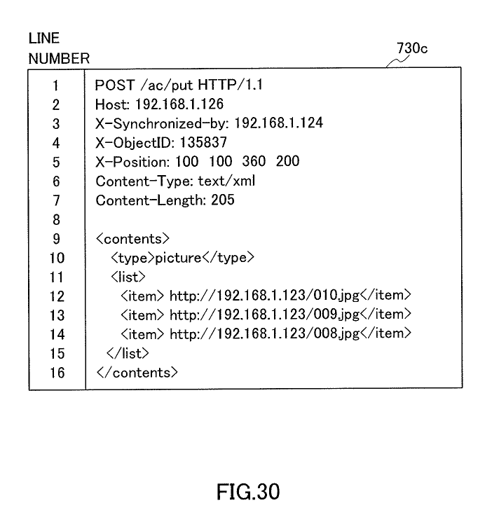

FIG. 30 is a drawing showing an example of the contents of an active content display request created by synchronization section 360c. Here, a case will be described by way of example in which the active content display request shown in FIG. 9 of Embodiment 1 is received.

As shown in FIG. 30, in active content display request 730c created by synchronization section 360c, the destination (line number 2) in the metadata part (HTTP request header part) of active content display request 730 in FIG. 9 has been changed to the IP address of the communicating party. Also, additional information (line number 3) and synchronization information (line numbers 4 and 5) have been inserted in the metadata part (HTTP request header part) of active content display request 730 in FIG. 9.

The additional information is for having the communicating party that transmitted an active content display request determine whether or not this is an active content display request from that apparatus, and preventing an active content display request loop.

In principle, if an active content display request is received while first and second videophones 300c-1 and 300c-2 are synchronized, the received active content display request is transferred to the communicating party. In this case, unless a countermeasure of some kind is devised, once active content display request transfer is started, transfer will be repeated endlessly between first and second videophones 300c-1 and 300c-2.

Thus, first and second videophones 300c-1 and 300c-2 add additional information indicating their own IP address (for example, “X-Synchronized-by: 192.168.1.124” as shown in FIG. 30) to an active content display request transferred between them. Also, first and second videophones 300c-1 and 300c-2 do not perform transfer of an active content display request to which additional information has been added to an IP address indicated by that additional information.

Synchronization information is information for synchronizing screen states between first and second videophones 300c-1 and 300c-2. For example, in FIG. 30, synchronization information “X-ObjectID: 135837” (line number 4) and synchronization information “X-Position: 100 100 360 200” is written. This specifies that an object specified by “X-ObjectID: 135837” is to be drawn at a position of screen coordinates “100,100” with a size of “360” horizontally and “200” vertically.

Specifically, for an active content display request in which additional information (line number 3 in FIG. 30) has been written, CGI 332c determines that this is an active content display request received from the communicating party, and does not proceed to step S4030 in FIG. 28. That is to say, active content display request directing can be inhibited by additional information.

In step S4040 in FIG. 29, synchronization section 360c determines whether or not processing should be continued, based on whether or not termination of processing has been directed by means of a user operation or the like, and returns to step S4010 if processing is to be continued (S4040: YES).

If a POST request specifying a content body has not been received (S4020: NO), synchronization section 360c next determines in step S4050 whether or not there has been an operation of some kind on a graphic object on its own apparatus side. If there has been an operation (S4050: YES), synchronization section 360c proceeds to step S4060.

In step S4060, synchronization section 360c transmits the contents of the operation on a graphic object to the communicating party, and proceeds to step S4040.

If there has been no particular operation on a graphic object on its own apparatus side (S4050: NO), synchronization section 360c next determines in step S4070 whether or not contents of an operation performed on a graphic object have been received from the communicating party. Synchronization section 360c proceeds to step S4080 if control operation contents have been received from the communicating party (S4070: YES), or proceeds to step S4040 if control operation contents have not been received from the communicating party (S4070: NO).

In step S4080, synchronization section 360c implements received control operation contents for a graphic object by means of CGI 332c of its own apparatus, and proceeds to step S4040. Control operation contents may also be implemented by having HTTP server 331 pass received control operation contents directly to CGI 332c.

While a call is not being performed with a communicating party (S4010: NO), synchronization section 360c repeats the determination processing in step S4040.

Then, if processing is not to be continued (S4040: NO), synchronization section 360c terminates the series of processing steps.

By means of such operation, synchronization section 360c can perform synchronization of graphic object display with a communicating party. Also, by deploying videophone 300c having synchronization section 360c of this kind, a content body can be moved between separate networks via videophone 300c by means of an intuitive control operation.

The overall operation of remote control system 100c will now be described, using an example of user operation.

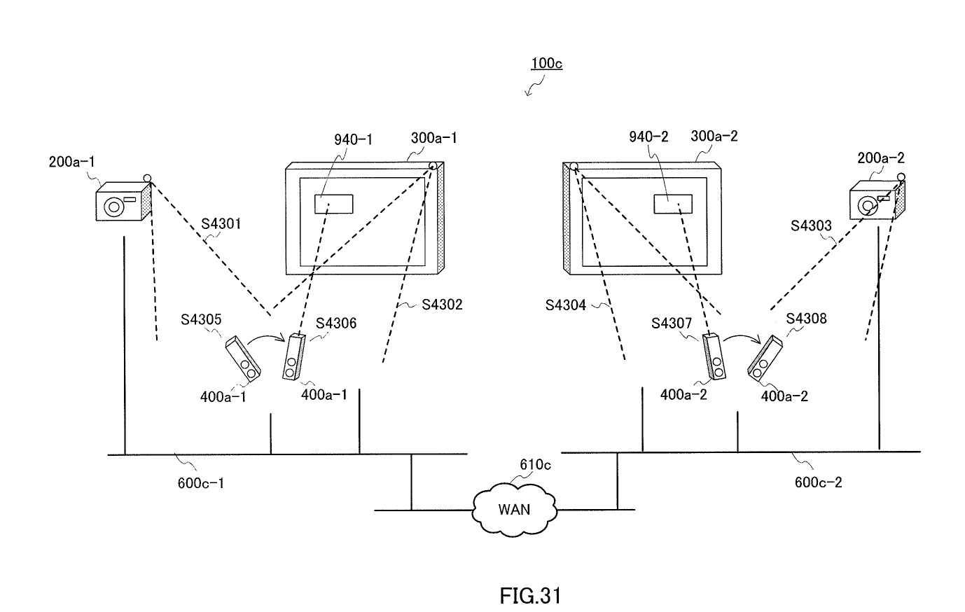

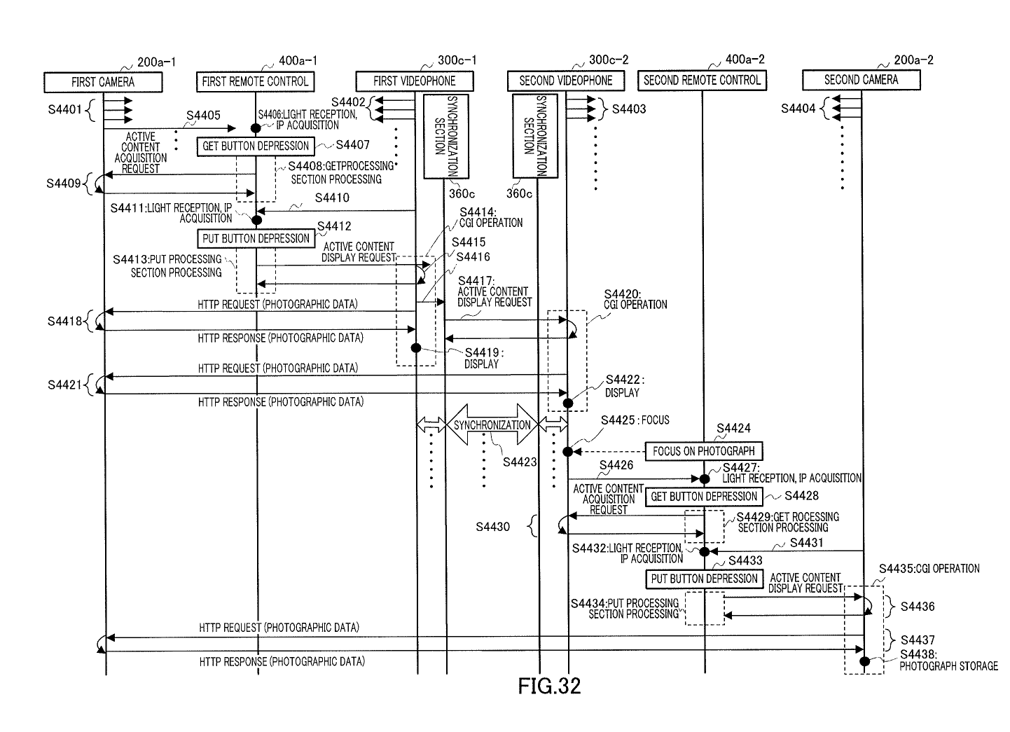

FIG. 31 is a drawing showing schematically an example of the overall operation of remote control system 100c, and FIG. 32 is a sequence diagram of an example of the overall operation shown in FIG. 31. Internal apparatus operations and data flows in remote control system 100c are described below using FIG. 31 and FIG. 32.

It is assumed here that a call has been established between first videophone 300c-1 and second videophone 300c-2. The operation of remote control system 100c will be described for a case in which a first user first presses the GET button with first remote control 400a-1 directed toward first camera 200a-1, and then presses the PUT button with first remote control 400a-1 directed toward first videophone 300c-1.

Also, the operation of remote control system 100c will next be described for a case in which a second user first presses the GET button with second remote control 400a-2 directed toward second videophone 300c-2, and then presses the PUT button with second remote control 400a-2 directed toward second remote control 400a-2. That is to say, operation will be described for a case in which a first user and second user perform drag and drop operations on cameras 200a and videophones 300c using remote controls 400a.

First, optical signals indicating the host section of the respective IP addresses are being transmitted from first camera 200a-1 and first videophone 300c-1 (S4301, S4302, S4401, S4402), and it is possible for those optical signals to be received by first remote control 400a-1. Also, optical signals indicating the host section of the respective IP addresses are also being transmitted from second camera 200a-2 and second videophone 300c-2 (S4303, S4304, S4403, S4404), and it is possible for those optical signals to be received by second remote control 400a-2.

When first remote control 400a-1 is now directed toward first camera 200a-1 by the first user (S4305), first remote control 400a-1 receives a first camera 200a optical signal, and acquires the IP address of first camera 200a-1 (S4405, S4406). Then, when GET button 410 is pressed by the first user (S4407), GET processing section 470 starts the processing shown in FIG. 6 (S4408). GET processing section 470 transmits an active content acquisition request to first camera 200a-1 via first LAN 600c-1, and in response, acquires a photograph list of photographic data stored in first camera 200a-1 (S4409).

Next, when first remote control 400a-1 is directed toward first videophone 300c-1 by the first user (S4403), first remote control 400a-1 receives a first videophone 300c-1 optical signal, and acquires the IP address of first videophone 300c-1 (S4410, S4411). Then, when PUT button 420 is pressed by the first user (S4412), PUT processing section 480 starts the processing shown in FIG. 6 (S4413). PUT processing section 480 transmits an active content display request specifying photographic data of first camera 200a-1 to first videophone 300c-1 via first LAN 600c-1.

On receiving the active content display request, first videophone 300c-1 activates CGI 332c, and starts the CGI operation shown in FIG. 19 (S4414). CGI 332c sends back a response to the active content display request (S4415), and also instructs synchronization section 360c to start the operation shown in FIG. 29 (S4416). On receiving this instruction, synchronization section 360c of first videophone 300c-1 transmits an active content display request specifying photographic data of first camera 200a-1 to second videophone 300c-2 via WAN 610c.

Also, CGI 332c acquires photographic data held by first camera 200a-1 based on the active content display request (S4418), and displays the acquired photographic data on display/speaker section 321c (S4419).

On receiving the active content display request, second videophone 300c-1 activates CGI 332c, and starts the CGI operation shown in FIG. 19 (S4420). CGI 332c acquires photographic data held by first camera 200a-1 via WAN 610c based on the active content display request (S4421), and displays the acquired photographic data on display/speaker section 321c (S4422).

As a result, identical graphic objects 940-1 and 940-2 that are photographic data held by first camera 200a-1 are displayed on first videophone 300c-1 and second videophone 300c-2. That is to say, at that point in time, the first objective of the first user—to show photographs of his own apparatus (the “local apparatus”) to the second user—is achieved.

Then continuous synchronization of the display states of graphic objects 940-1 and 940-2 is performed by synchronization section 360c of first videophone 300c-1 and synchronization section 360c of second videophone 300c-2 (S4423). Synchronization section 360c is instructed to perform synchronization from CGI 332c on the local apparatus side, but synchronization section 360c is not instructed to perform synchronization from CGI 332c on the counterpart apparatus side. The reason for this is that measures are taken to prevent an active content display request loop.

It will now be assumed, for example, that the first user suggests copying of photographic data to the second user, telling the second user via a videophone channel, “You can copy that photograph if you like it,” and the second user likes the displayed photograph.

When graphic object 940-2 of second videophone 300c-2 is focused upon by the second user using second remote control 400a-2 (S4424), second videophone 300c-2 detects this (S4425). Then, since second remote control 400a-2 is being directed toward second videophone 300c-2 (S4307), second remote control 400a-2 receives a second videophone 300c-2 optical signal, and acquires the IP address of second videophone 300c-2 (S4426, S4427). Next, when GET button 410 is pressed by the second user (S4428), GET processing section 470 starts the processing shown in FIG. 6 (S4429). GET processing section 470 transmits an active content acquisition request to second videophone 300c-2 via second LAN 600c-2, and in response, acquires a URL of a graphic object displayed on second videophone 300c-2 (S4430).

Next, when second remote control 400a-2 is directed toward second camera 200a-2 by the second user (S4308), second remote control 400a-2 receives a second camera 200a-2 optical signal, and acquires the IP address of second camera 200a-2 (S4431, S4432). Then, when PUT button 420 is pressed by the second user (S4432), PUT processing section 480 starts the processing shown in FIG. 6 (S4434). PUT processing section 480 transmits to second camera 200a-2 an active content recording request specifying photographic data of a graphic object that is focused upon in second videophone 300c-1.

On receiving the active content recording request, second camera 200a-2 activates CGI 332c, and starts the CGI operation shown in FIG. 19 (S4435). CGI 332c sends back a response to the active content recording request (S4436).

As described above, a URL of original photographic data is associated with each graphic object. Therefore, an original URL of first camera 200a-1 is associated with graphic object 940-2 acquired from first camera 200a-1 and displayed on second videophone 300c-2. Camera/microphone section 322c of second camera 200a-2 therefore acquires photographic data held by first camera 200a-1 via WAN 610c based on the active content recording request (S4437), and stores the acquired photographic data in photograph storage section 220 (S4438). By this means, photographic data held in first camera 200a-1 is finally copied to second camera 200a-2.

By means of such operation of remote control system 100c, a user obtains a sensation of exchanging active content with a communicating party via a videophone 300c screen by means of remote control 400c drag and drop operations in real space.

Thus, according to this embodiment, a user can perform content body copying and moving between Internet home appliances installed in physically separate locations with the same kind of sensation as when performing a normal drag and drop operation.

Variations such as described below can also be applied to the configurations of the above-described embodiments.

A GET button and PUT button of a remote control may be integrated into a single button. In this case, GET button depression timing may be replaced by timing at which a transition is made from a state in which the integrated button is not being pressed to a state in which that button is pressed, and PUT button depression timing may be replaced by timing at which a transition is made from a state in which the integrated button is pressed to a state in which that button is not being pressed.

A GET button, PUT button, and integrated button need not be key switches, but may be replaced by an input device that enables state changes corresponding to depression and release to be performed without performing physical depression, as in the case of a touch pad or touch panel. Also, a change in a 3-dimensional position or attitude of a remote control, a change of gripping force of a remote control, or the like, may be detected using an acceleration sensor, motion sensor, or pressure sensor, and GET button and PUT button operation contents may be replaced by detection results thereof.

A remote control may be provided with an illumination apparatus such as a laser pointer that outputs a light beam in conformity with the orientation of the light receiving section of the remote control. By this means, a user can achieve accurate orientation of a remote control by means of a network that is a desired control operation target, and can improve operating precision. Also, on/off control and color variation of a light beam may be linked to operation of a GET button and PUT button. By this means, a user can perform control operations while confirming control operation contents for each of his own Internet home appliances.

An optical signal that is output periodically from an Internet home appliance may use light other than infrared light—for example, visible light. If visible light is used as an optical signal, a user can confirm the presence or absence of optical signal output, and can perform control operations more intuitively.

An Internet home appliance may be provided with an apparatus for notifying a user that identification information is being transmitted by means of an optical signal. Specifically, a visible-light lamp may be provided as an indicator that lights up, or a speaker may be provided that outputs speech, in the vicinity of an optical beacon.

Identification information may be transmitted by means of a radio signal as well as an optical signal. However, in the case of a radio signal or sound signal, the effects of reflection are significant, and a component for reducing such effects should be added.

Internet home appliance identification information is not limited to the host section of an IP address, and other information may also be applied that identifies a relevant Internet home appliance, and as a result enables that Internet home appliance to be accessed. For example, if the communication capacity available for transmission of identification information is sufficiently high, an IP address itself may be used as identification information. Furthermore, identification information other than an IP address may be used. For example, if an Internet home appliance is assigned identification information that does not duplicate that of another Internet home appliance during factory production, that identification information may be used. Similarly, if a host name is set for an Internet home appliance by a user, that host name may be used. In addition, an FQDN (fully qualified domain name) may be used. In these cases, however, it is necessary to provide a table in which identification information and IP addresses are mutually associated.

A remote control or Internet home appliance may be additionally provided with a function for notifying a user by means of light or speech of which Internet home appliance a remote control is currently receiving identification information from. This notification may also be performed by means of a user inquiry. By this means, a user can perform control operations while confirming in real time which Internet home appliance a remote control can perform operations on. Provision may also be made for the above notification to be performed by the display of Internet home appliance information (a photo of the external appearance, a product name, or the like).

Provision may also be made for IP address calculation to be performed only when GET button or PUT button depression is performed. By this means, the processing load of a remote control can be reduced.

Along as it is capable of being activated by another Internet home appliance via an HTTP server, a CGI can use a construction technique of a general HTTP server, irrespective of its installation method. For example, a server side script such as JSP (Java server page) or PHP (hypertext preprocessor), or a Java (registered trademark) servlet may be installed. Also, another technology such as SOAP (simple object access protocol) may be used as a technology for implementing a function for performing a remote function call in HTTP. Furthermore, control of an active content acquisition request or the like may be implemented by means of a method logically equivalent to a remote procedure call of a server client method other than HTTP, such as RPC (remote procedure call), for example.

When active content is moved, provision may be made for active content to be deleted from the movement source, or for the user to select whether or not such deletion is to be performed. In this case, it is necessary for a URL of a content body included in access information to be rewritten in line with movement of the content body.

Targets of linked control are not limited to the Internet home appliances mentioned in the above embodiments, and can be, for example, various kinds of AV devices that hold or output image data, video data, or speech data, such as televisions and HDD recorders, and various kinds of white goods such as air conditioners and refrigerators.

The disclosure of Japanese Patent Application No. 2008-197074, filed on Jul. 30, 2008, including the specification, drawings and abstract, is incorporated herein by reference in its entirety.

### INDUSTRIAL APPLICABILITY

A remote control apparatus, Internet home appliance, remote control system, and remote control method according to the present invention are suitable for use as a remote control apparatus, Internet home appliance, remote control system, and remote control method that enable an Internet home appliance to be remotely controlled with less of a burden on a user.

### REFERENCE SIGNS LIST

100, 100a, 100b, 100c Remote control system
200, 200a Camera
200b Air conditioner
210, 310 Optical beacon
220 Photograph storage section
230, 230a, 230b, 330, 330a, 330c, 430 Network interface
231, 331 HTTP server
232, 232a, 232b, 332, 332a, 332c CGI
233, 333, 431 Network information storage section
240, 340 Optical beacon transmitting section
250b Air conditioner function section
300, 300a Television
300c Videophone
320 Video display section
320c Videophone section
321 Display
321c Display/speaker section
322 Tuner
322c Camera/microphone section
323 Video input section
323c Videophone transmitting/receiving section
324 Moving image display section
324c Audiovisual display section
325 Graphic display section
326, 326c Superimposition section
327 User input receiving section
328 Interpretation section
329 Storage section
350 External input device
360c Synchronization section
400, 400a Remote control
410 GET button
420 PUT button
440 Active content holding section
450 Light receiving section
451 Hole
452 Light receiving element
460 Decoding section
470 GET processing section
480 PUT processing section
490a Television operating section
600 Communication network
600c LAN
610c WAN

1-12. (canceled)

13. A remote control apparatus for performing remote control of at least one Internet home appliance that sends self-identification information by means of a radio signal, the remote control apparatus comprising:
a signal receiving section that receives the radio signal sent from the Internet home appliance that is a target of the remote control;
a communication network connection section that connects to a communication network to which the Internet home appliance is connected; and
a remote control section that, when identification information of the Internet home appliance is received by the signal receiving section when a predetermined control operation is performed, performs remote control of the Internet home appliance indicated by that identification information via the communication network, wherein:
the predetermined control operation includes a first control operation and a second control operation; and
the remote control section issues a request for a first operation to a first Internet home appliance indicated by identification information received when the first control operation is performed, and issues a request for a second operation different from the first operation to a second Internet home appliance indicated by identification information received when the second control operation is performed.

14. The remote control apparatus according to claim 13, wherein:
the first operation is an operation whereby access information for accessing a content body held by the first Internet home appliance is sent back; and the second operation is an operation whereby the second Internet home appliance acquires the content body based on the access information.

15. The remote control apparatus according to claim 13, wherein:
the identification information is an address in the communication network; and
the remote control section requests the first operation and the second operation via the communication network.

16. The remote control apparatus according to claim 13, further comprising a device operation control section that controls an operation other than the first operation of the first Internet home appliance, or an operation other than the second operation of the second Internet home appliance.

17. The remote control apparatus according to claim 13, further comprising a bar-shaped case forming an external shape of that apparatus,
wherein the signal receiving section has:
a columnar hole that is located in a front end of the case, with an axial direction of the signal receiving section made to match a lengthwise direction of the case, and that has an inner surface covered with a material that absorbs the received signal; and
an element that is located at a bottom of the hole, and receives the received signal.

18. The remote control apparatus according to claim 14, wherein the second operation further includes an operation whereby the second Internet home appliance displays or records the content body acquired based on the access information.

19. An Internet home appliance that is operated by the remote control apparatus according to claim 3, the Internet home appliance comprising:
a signal sending section that sends self-identification information by means of a radio signal;
a communication network connection section that connects to a communication network;
a remote control receiving section that receives remote control from the remote control apparatus via the communication network;
a video display section that displays a graphic object indicating remote control target content; and
a storage section that stores identification information of another Internet home appliance having the remote control target content and the graphic object,
wherein the remote control receiving section, on receiving remote control that selects the graphic object being displayed from the remote control apparatus, acquires, and transmits to the remote control apparatus via the network, identification information of the other Internet home appliance corresponding to the graphic object stored in the storage section and selected by the remote control.

20. A remote control system for performing remote control of at least one Internet home appliance that sends self-identification information by means of a radio signal, the remote control system comprising:
a remote control apparatus having a signal receiving section that receives the radio signal sent from the Internet home appliance that is a target of the remote control, a communication network connection section that connects to a communication network to which the Internet home appliance is connected, and a remote control section that, when identification information of the Internet home appliance is received by the signal receiving section when a first control operation is performed, issues a request for a first operation to a first Internet home appliance indicated by that identification information via the communication network, and when identification information of the Internet home appliance is received by the signal receiving section when a second control operation is performed, issues a request for a second operation different from the first operation to a second Internet home appliance indicated by that identification information via the communication network; and
the Internet home appliance having a signal sending section that sends self-identification information by means of the radio signal, a communication network connection section that connects to the communication network, a video display section that displays a graphic object indicating remote control target content in a predetermined form at a predetermined location, a storage section that, when the remote control target content is content possessed by another Internet home appliance, stores identification information of the other Internet home appliance and the graphic object, and a remote control receiving section that, on receiving remote control that selects the graphic object being displayed from the remote control apparatus via the communication network, acquires, and transmits to the remote control apparatus via the network, identification information of the other Internet home appliance corresponding to the graphic object stored in the storage section and selected by the remote control.

21. A remote control method for performing remote control of at least one Internet home appliance that sends self-identification information by means of a radio signal, the remote control system comprising:
a step of, when a predetermined control operation is performed, detecting that the predetermined control operation has been performed; and
a step of performing remote control of the Internet home appliance indicated by identification information received when the fact that the predetermined control operation has been performed is detected among identification information of the Internet home appliance received by a signal receiving section that receives the radio signal sent from the Internet home appliance that is a target of the remote control via a communication network to which that Internet home appliance is connected, wherein:
the predetermined control operation includes a first control operation and a second control operation; and
the step of performing remote control issues a request for a first operation to a first Internet home appliance indicated by identification information received when the first control operation is performed, and issues a request for a second operation different from the first operation to a second Internet home appliance indicated by identification information received when the second control operation is performed.
